(19) United States
(12) Patent Application Publication
(10) Pub. No.: US 2026/0333163 A1
(43) Pub. Date: Oct. 22, 2026

(54) METHOD, USER EQUIPMENT AND ACCESS NETWORK NODE

(71) Applicant: NEC Corporation, Tokyo (JP)

(72) Inventors: Xuelong Wang, Guidford (GB); Yuhua Chen, London (GB); Pravjyot Deogun, Milton Keynes (GB); Hisashi Futaki, Tokyo (JP)

(73) Assignee: NEC Corporation, Tokyo (JP)

(21) Appl. No.: 19/168,872

(22) PCT Filed: Mar. 29, 2024
(86) PCT No.: PCT/JP2024/012952

§ 371 Date: Sep. 25, 2025

(30) Foreign Application Priority Data
Apr. 5, 2023 (GB) 2305106.3

(51) Int. Cl. H04W 36/06; H04W 36/00; H04W 36/30

(52) U.S. Cl. CPC H04W 36/06; H04W 36/0061; H04W 36/305

(57) ABSTRACT

The present disclosure relates to a method performed by a user equipment, UE, the method comprising: receiving, from an access network node that provides a source cell, an indication of a first set of one or more candidate target cells for a lower layer mobility procedure; and determining a second set of candidate target cells for the lower layer mobility procedure, wherein the second set of cells is a subset of the first set of cells; wherein the cells in the second set of cells are prioritised for selection as the target cell.

### TECHNICAL FIELD

The present disclosure relates to a communication system.

### BACKGROUND ART

The disclosure has particular but not exclusive relevance to wireless communication systems and devices thereof operating according to the 3rd Generation Partnership Project (3GPP) standards or equivalents or derivatives thereof (including LTE-Advanced, Next Generation or 5G networks, future generations, and beyond). The disclosure has particular, although not necessarily exclusive, relevance to lower-layer triggered mobility (LTM), radio link monitoring (RLM) and radio link failure (RLF) in ‘New Radio’ systems (also referred to as ‘Next Generation’ systems), and similar systems.

Recent developments of the 3GPP standards are referred to as the Long-Term Evolution (LTE) of Evolved Packet Core (EPC) network and Evolved UMTS Terrestrial Radio Access Network (E-UTRAN), also commonly referred as ‘4G’. In addition, the term ‘5G’ and ‘new radio’ (NR) refer to an evolving communication technology that is expected to support a variety of applications and services. Various details of 5G networks are described in, for example, the ‘NGMN 5G White Paper’ V1.0 by the Next Generation Mobile Networks (NGMN) Alliance, which document is available from https://www.ngmn.org/5 g-white-paper.html. 3GPP intends to support 5G by way of the so-called 3GPP Next Generation (NextGen) radio access network (RAN) and the 3GPP NextGen core network.

Under the 3GPP standards, a NodeB (or an eNB in LTE, gNB in 5G) is the radio access network (RAN) node (or simply ‘access node’, ‘access network node’ or ‘base station’) via which communication devices (user equipment or ‘UE’) connect to a core network and communicate with other communication devices or remote servers. For simplicity, the present application will use the term RAN node, base station, or access network node to refer to any such access nodes.

A UE may communicate using a Special Cell (SpCell), such as a primary serving cell (PCell) of a Master Cell Group (MCG). If the UE 3 is configured for communication using a secondary cell group (SCG), then the UE 3 may also communicate via a primary SCG cell (PSCell). A UE 3 may also be provided with an indication of one or more candidate target cells, to which the UE 3 can switch. Following detection of radio link failure (RLF) at the primary serving cell, the UE may initiate a radio resource control (RRC) connection re-establishment procedure, which may include a random access procedure.

### CITATION LIST

### Non Patent Literature

NPL 1: The ‘NGMN 5G White Paper’ V1.0 by the Next Generation Mobile Networks (NGMN) Alliance, available from https://www.ngmn.org/5 g-white-paper.html.

### SUMMARY OF INVENTION

### Technical Problem

Historically, mobility between different cells in cellular communications has been based on communication at higher layers, such as layer 3 (e.g., the L3 or radio resource control (RRC) layer) signalling. More recently, with a view to providing enhanced mobility, consideration has given to developing and providing support for layer 1 (e.g., the L1 or physical (PHY) layer) and/or layer 2 (e.g., the L2 or media access control (MAC) layer) centric mobility (also referred to as L1/L2 centric mobility) rather than at higher layers (e.g., the RRC layer). Such L1/L2 centric mobility (also referred to as L1/L2 triggered mobility or ‘LTM’) has prospects for improving mobility for devices operating both below 7 GHz and in mm Wave bands, for example by supporting lower handover latency and improved robustness.

However, improved methods and apparatus for handling RLM and RLF when the UE communicates via a SpCell, and is provided with an indication of one or more candidate target cells for LTM, are needed. For example, methods and apparatus for more efficient and reliable switching to communicate via a candidate cell are needed. More generally, improved apparatus and methods for handling RLF and lower layer triggered mobility are needed.

### Solution to Problem

In one aspect the disclosure provides a method performed by a user equipment, UE, the method comprising: receiving, from an access network node that provides a source cell, an indication of a first set of one or more candidate target cells for a lower layer mobility procedure; and determining a second set of candidate target cells for the lower layer mobility procedure, wherein the second set of cells is a subset of the first set of cells; wherein the cells in the second set of cells are prioritised for selection as the target cell.

The method may further comprise: obtaining, for at least one of the candidate cells of the first set, timing advance information for communication using the cell; and determining to include the candidate cells for which the timing advance information is obtained in the second set of cells.

Obtaining the timing advance information may comprise receiving the timing advance information from the access network node via the source cell. The timing advance information may be received, from the access network node, in configuration information transmitted in the source cell.

The method may further comprise: determining, for a candidate cell for which the timing advance information has been obtained, based on an associated timer, whether the timing advance information is valid; if it is determined that the timing advance information for the candidate cell is not valid, removing the candidate cell from the second set; and if it is determined that the timing advance information for the candidate cell is valid, maintaining the candidate cell in the second set.

The method may comprise determining that the timing advance information for the candidate cell is not valid if the timer has expired.

The method may further comprise: receiving, from the access network node or another access network node that provides a cell of the first set of cells, one or more communication resources for use in obtaining the timing advance information; and obtaining the timing advance information using the one or more communication resources.

The one or more communication resources may comprise one or more physical random access channel, PRACH, resources.

The method may further comprise transmitting, to the access network node, a request for the one or more communication resources for use in obtaining the timing advance information.

The second set of cells may comprise at least one cell for which valid timing advance information is available at the UE, and the second set of cells may comprise at least one cell for which valid timing advance information is not available at the UE; and the method may further comprise determining a ranking or priority for selection of the cells in the second set of cells as a target cell, based on whether valid timing advance information is available for the cells.

The method may further comprise receiving, from the access network node, an indication of a maximum number of cells for which the UE is to maintain corresponding timing advance information.

The method may further comprise transmitting, to the access network node, an indication of a maximum number of cells for which the UE is to maintain corresponding timing advance information.

The method may further comprise: receiving, from the access network node, an indication of the identity of one or more of the candidate target cells for which the UE is to obtain corresponding timing advance information; and obtaining the timing advance information for the indicated cells.

The method may further comprise: determining to obtain timing advance information for one or more cells of the first set of cells; wherein the UE determines whether to obtain timing advance information for a cell based on at least one measurement of a transmission of the cell.

The UE may determine whether to obtain the timing advance information for a cell based on whether a random access channel, RACH, resource for the cell, for obtaining the timing advance information is available, at the UE.

The method may further comprise transmitting, to the access network node, an indication of the cells included in the second set of candidate cells.

The method may comprise transmitting, to the access network node, the indication of the cells included in the second set of candidate cells after adding or removing a cell from the second set of cells.

The method may further comprise: performing one or more measurements of transmissions of at least one cell of the second set of cells; and determining a ranking or priority for selection of the cells in the second set of cells as a target cell based on the measurements.

The measurements may comprise measurements of at least one of a reference signal received power, RSRP, reference signal received quality, RSRQ, or RSRP and signal to noise interference ratio, RSRP-SINR.

The method may further comprise: receiving measurement configuration information for the one or more measurements from the access network node; and performing the one or more measurements based on the measurement configuration information.

The method may further comprise: determining that radio link failure, RLF, has occurred in the source cell; and performing the lower layer mobility procedure after determining that the RLF has occurred.

Determining that RLF has occurred may comprise performing a radio link monitoring, RLM, procedure.

The RLM procedure may comprise performing measurements of transmissions of the source cell.

The RLM procedure further comprises performing measurements of transmissions of at least one cell of the second set of cells.

The RLM procedure may comprise a first RLM process for monitoring the source cell, and one or more second RLM processes for monitoring cells of the second set of cells.

The UE may determine that RLF has occurred if the UE determines that RLF has occurred for both the source cell and the cells of the second set of cells monitored using the second RLM processes.

The RLM procedure may comprise a joint RLM process for monitoring the source cell and for monitoring cells of the second set of cells.

The method may further comprise: determining that a failure of a handover procedure for handover of the UE from the source cell has occurred; and performing the lower layer mobility procedure after determining that the failure of the handover procedure has occurred.

The lower layer procedure may be a layer 1, L1, or layer 2, L2, based mobility procedure.

The method may comprise: determining that RLF has occurred in the source cell; and determining to maintain, for a first time period, a configuration for an RRC connection via the source cell if the second set of cells includes at least one cell.

The source cell may be associated with a central unit of a base station; and the method may comprise determining to maintain, for the first time period, the configuration for the RRC connection via the source cell if the second set of cells includes at least one cell that is associated with the central unit.

The method may further comprise determining to perform the lower layer mobility procedure.

The lower layer mobility procedure may comprise establishing or re-establishing a radio resource control, RRC, connection via a cell of the second set of cells.

The method may further comprise: receiving, from the access network node, an indication of a maximum number of cells to be included in the second set of cells.

The method may further comprise: transmitting, to the access network node, an indication of a maximum number of cells that the UE is to include in the second set of cells.

In another aspect the disclosure provides a method performed by an access network node that provides a source cell, the method comprising: transmitting, to a user equipment, UE, in the source cell, an indication of a first set of one or more candidate target cells for a lower layer mobility procedure; and receiving, from the UE, an indication of a second set of candidate target cells for the lower layer mobility procedure, wherein the second set of cells is a subset of the first set of cells; wherein the cells in the second set of cells are prioritised for selection as a target cell for the lower layer mobility procedure.

The method may further comprise: transmitting, to the UE, one or more communication resources for use by the UE to obtain timing advance information for a cell of the second set of cells; wherein the UE determines the cells to be included in the second set of cells based on the timing advance information.

The one or more communication resources may comprise one or more physical random access channel, PRACH, resources.

The method may further comprise receiving, from the UE, a request for the one or more communication resources for use by the UE to obtain the timing advance information.

The method may further comprise transmitting, to the UE, an indication of a maximum number of cells for which the UE is to maintain corresponding timing advance information.

The method may further comprise receiving, from the UE, an indication of a maximum number of cells for which the UE is to maintain corresponding timing advance information.

The method may further comprise: transmitting, to the UE, an indication of the identity of one or more of the candidate target cells for which the UE is to obtain corresponding timing advance information.

The method may further comprise: transmitting, to the UE, measurement configuration information for one or more measurements to be performed by the UE of transmissions of at least one cell of the second set of cells.

The lower layer procedure may be a layer 1, L1, or layer 2, L2, based mobility procedure.

The method may further comprise determining to perform the lower layer mobility procedure.

The method may further comprise: transmitting, to the UE, an indication of a maximum number of cells to be included in the second set of cells.

The method may further comprise: receiving, from the UE, an indication of a maximum number of cells that the UE is to include in the second set of cells.

In another aspect the disclosure provides a user equipment, UE, comprising: means for receiving, from an access network node that provides a source cell, an indication of a first set of one or more candidate target cells for a lower layer mobility procedure; and means for determining a second set of candidate target cells for the lower layer mobility procedure, wherein the second set of cells is a subset of the first set of cells; wherein the cells in the second set of cells are prioritised for selection as the target cell.

In another aspect the disclosure provides an access network node configured to provide a source cell, the access network node comprising: means for transmitting, to a user equipment, UE, in the source cell, an indication of a first set of one or more candidate target cells for a lower layer mobility procedure; and means for receiving, from the UE, an indication of a second set of candidate target cells for the lower layer mobility procedure, wherein the second set of cells is a subset of the first set of cells; wherein the cells in the second set of cells are prioritised for selection as a target cell for the lower layer mobility procedure.

In another aspect the disclosure provides a method performed by a user equipment, UE, the method comprising: receiving, from an access network node that provides a source cell, an indication of a first set of one or more candidate target cells for a lower layer mobility procedure; determining a second set of candidate target cells for the lower layer mobility procedure, wherein the second set of cells is a subset of the first set of cells; and selecting a cell as a target cell for the lower layer mobility procedure; wherein the UE prioritises the cells in the second set of cells for selection as the target cell.

### BRIEF DESCRIPTION OF DRAWINGS

Embodiments of the disclosure will now be described, by way of example, with reference to the accompanying drawings in which:

FIG. 1 schematically illustrates a mobile (‘cellular’ or ‘wireless’) communication system;

FIG. 2 illustrates a typical frame structure that may be used in the communication system of FIG. 1;

FIG. 3 is a schematic block diagram illustrating the main components of a DU 50 that may be used as part of the RAN node 5 for the communication system 1 shown in FIG. 1;

FIG. 4 is a schematic block diagram illustrating the main components of a CU 60 that may be used as part of the RAN node 5 for the communication system 1 shown in FIG. 1;

FIG. 5 shows a mobility procedure in which handover occurs from a source base station to a target base station;

FIG. 6 shows a random access (RA) procedure that may be performed in the system of FIG. 1;

FIG. 7 shows an example of Intra-CU inter-DU mobility;

FIG. 8 illustrates an exemplary method of inter-DU mobility;

FIG. 9 shows an inter-cell inter-DU method;

FIG. 10 shows a base station triggered L1 mobility method including measurement report filtering;

FIG. 11 illustrates a method in which radio link recovery occurs;

FIG. 12 illustrates a method in which radio link failure is determined;

FIG. 13 illustrates an example in which the UE 3 communicates with a base station 5 via an SpCell and determines that RLF has occurred;

FIG. 14 shows an example in which the UE 3 is provided with a set of fast recovery cells;

FIG. 15 shows an example in which the UE 3 stores a FRSC, and RLF occurs in the serving cell;

FIG. 16 shows an example in which the access network node that provides the source/serving cell communicates with the access network node that provides a candidate cell for LTM to obtain one or more PRACH resources requested by the UE;

FIG. 17 shows a further example of a fast recovery cell set;

FIG. 18 is a schematic block diagram illustrating the main components of a UE for the communication system of FIG. 1;

FIG. 19 is a schematic block diagram illustrating the main components of a base station for the communication system of FIG. 1; and

FIG. 20 is a schematic block diagram illustrating the main components of a core network node or function for the communication system of FIG. 1.

### DESCRIPTION OF EMBODIMENTS

### Overview

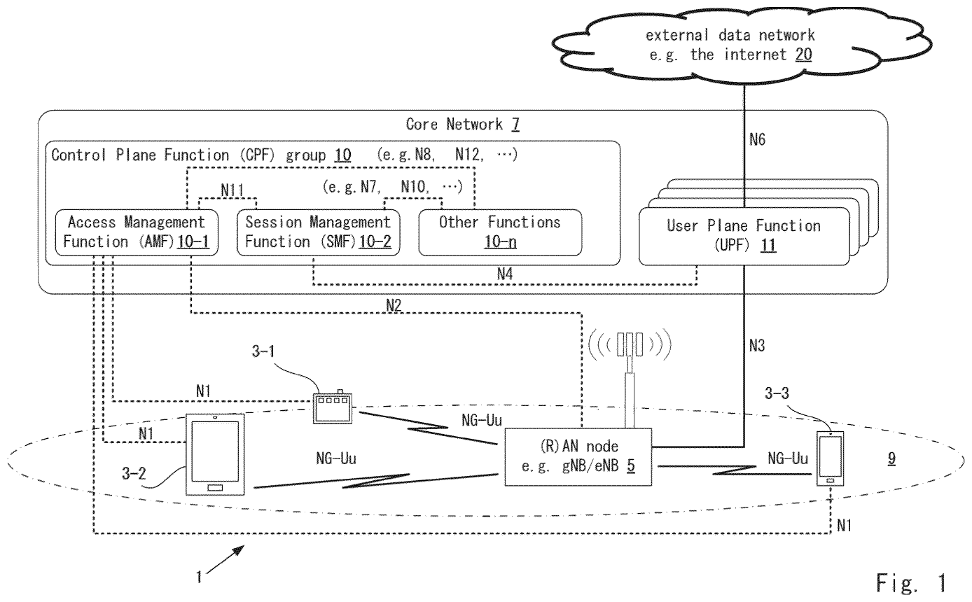

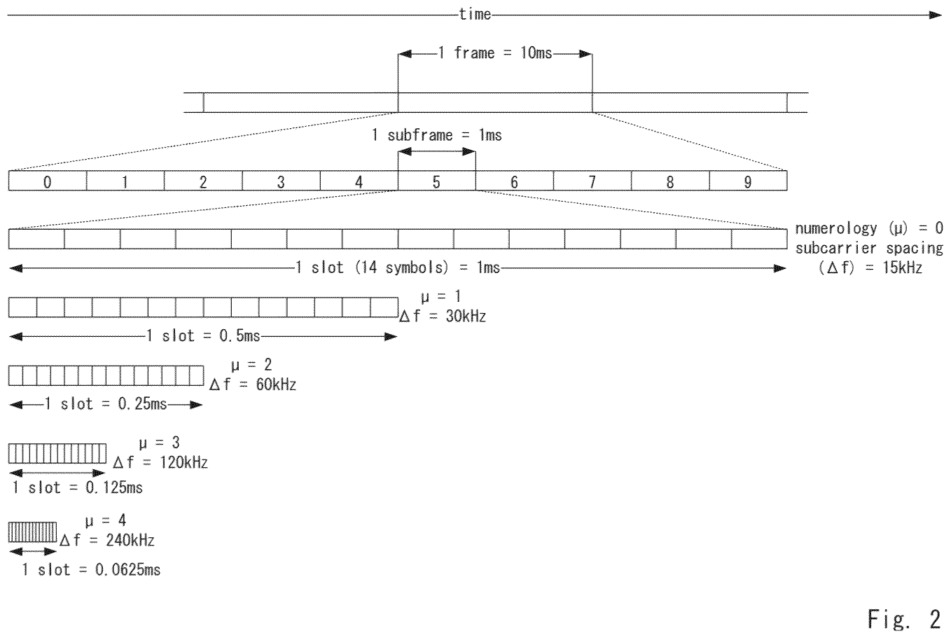

An exemplary communication system will now be described in general terms, by way of example only, with reference to FIGS. 1 and 2.

FIG. 1 schematically illustrates a mobile (‘cellular’ or ‘wireless’) communication system 1 to which embodiments of the present disclosure are applicable.

In the communication system 1, user equipment (UEs) 3-1, 3-2, 3-3 (e.g. mobile telephones and/or other mobile devices) can communicate with each other via a (radio) access network ((R)AN) node 5 (base station 5, RAN equipment 5) that operates according to one or more compatible radio access technologies (RATs). In the illustrated example, the (R)AN node 5 comprises a NR/5G base station 5 or ‘gNB’ 5 operating one or more associated cells 9. Communication via the base station 5 is typically routed through a core network 7 (e.g. a 5G core network or evolved packet core network (EPC)).

As those skilled in the art will appreciate, whilst three UEs 3 and one base station 5 are shown in FIG. 1 for illustration purposes, the system, when implemented, will typically include other base stations 5 and UEs 3.

Each base station 5 controls one or more associated cells 9 either directly, or indirectly via one or more other nodes (such as home base stations, relays, remote radio heads, distributed units, and/or the like). It will be appreciated that the base stations 5 may be configured to support 4G, 5G, 6G, and/or any other 3GPP or non-3GPP communication protocols.

The UEs 3 and their serving base station 5 are connected via an appropriate air interface (for example the so-called ‘Uu’ interface and/or the like). Neighbouring base stations 5 may be connected to each other via an appropriate base station to base station interface (such as the so-called ‘X2’ interface, ‘Xn’ interface and/or the like).

The core network 7 includes a number of logical nodes (or ‘functions’) for supporting communication in the communication system 1. In this example, the core network 7 comprises control plane functions (CPFs) 10 and one or more user plane functions (UPFs) 11. The CPFs 10 include one or more Access and Mobility Management Functions (AMFs) 10-1, one or more Session Management Functions (SMFs) and a number of other functions 10-n.

The base station 5 is connected to the core network nodes via appropriate interfaces (or ‘reference points’) such as an N2 reference point between the base station 5 and the AMF 10-1 for the communication of control signalling, and an N3 reference point between the base station 5 and each UPF 11 for the communication of user data. The UEs 3 are each connected to the AMF 10-1 via a logical non-access stratum (NAS) connection over an N1 reference point (analogous to the S1 reference point in LTE). It will be appreciated, that N1 communications are routed transparently via the base station 5.

One or more UPFs 11 are connected to an external data network (e.g. an IP network such as the internet) via reference point N6 for communication of the user data.

The AMF 10-1 performs mobility management related functions, maintains the NAS signalling connection with each UE 3 and manages UE registration. The AMF 10-1 is also responsible for managing paging. The SMF 10-2 provides session management functionality (that formed part of MME functionality in LTE) and additionally combines some control plane functions (provided by the serving gateway and packet data network gateway in LTE). The SMF 10-2 also allocates IP addresses to each UE 3.

The base station 5 of the communication system 1 is configured to operate at least one cell 9 on an associated TDD carrier that operates in unpaired spectrum. It will be appreciated that the base station 5 may also operate at least one cell 9 on an associated FDD carrier that operates in paired spectrum.

The base station 5 is also configured for transmission of, and the UEs 3 are configured for the reception of, control information and user data via a number of downlink (DL) physical channels and for transmission of a number of physical signals. The DL physical channels correspond to resource elements (REs) carrying information originated from a higher layer, and the DL physical signals are used in the physical layer and correspond to REs which do not carry information originated from a higher layer.

The physical channels may include, for example, a physical downlink shared channel (PDSCH), a physical broadcast channel (PBCH), and a physical downlink control channel (PDCCH). The PDSCH carries data sharing the PDSCH's capacity on a time and frequency basis. The PDSCH can carry a variety of items of data including, for example, user data, UE-specific higher layer control messages mapped down from higher channels, system information blocks (SIBs), and paging. The PDCCH carries downlink control information (DCI) for supporting a number of functions including, for example, scheduling the downlink transmissions on the PDSCH and also the uplink data transmissions on a physical uplink shared channel (PUSCH). The PBCH provides UEs 3 with the Master Information Block (MIB). It also, in conjunction with the PDCCH, supports the synchronisation of time and frequency, which aids cell acquisition, selection and re-selection. The UE 3 may receive a Synchronization Signal Block (SSB), and the UE 3 may assume that reception occasions of a PBCH, primary synchronization signal (PSS) and secondary synchronization signal (SSS) are in consecutive symbols and form a SS/PBCH block. The base station 5 may transmit a number of synchronization signal (SS) blocks corresponding to different DL beams. The total number of SS blocks may be confined, for example, within a 5 ms duration as an SS burst. The periodicity of the SSB transmissions may be indicated to the UE using any suitable signalling (e.g. per serving cell using ssb-periodicity ServingCell). The periodicity value for the SSB may be, for example, greater than or equal to 20 ms. For initial cell selection, the UE 3 may be configured to assume that an SS burst occurs with a periodicity of 2 frames. The UE 3 may also be provided with an indication of which SSBs within a 5 ms duration are transmitted (e.g. using ssb-Positions InBurst).

The DL physical signals may include, for example, reference signals (RSs) and synchronization signals (SSs). A reference signal (sometimes known as a pilot signal) is a signal with a predefined special waveform known to both the UE 3 and the base station 5. The reference signals may include, for example, cell specific reference signals, UE-specific reference signal (UE-RS), downlink demodulation signals (DMRS), and channel state information reference signal (CSI-RS).

Similarly, the UEs 3 are configured for transmission of, and the base station 5 is configured for the reception of, control information and user data via a number of uplink (UL) physical channels corresponding to REs carrying information originated from a higher layer, and UL physical signals which are used in the physical layer and correspond to REs which do not carry information originated from a higher layer. The physical channels may include, for example, the PUSCH, a physical uplink control channel (PUCCH), and/or a physical random-access channel (PRACH). The UL physical signals may include, for example, demodulation reference signals (DMRS) for a UL control/data signal, and/or sounding reference signals (SRS) used for UL channel measurement.

When the UE 3 initially establishes a radio resource control (RRC) connection with a base station 5 via a cell 9 it registers with an appropriate core network node (e.g., AMF, MME). The UE 3 is in the so-called RRC connected state and an associated UE context is maintained by the network. When the UE 3 is in the so-called RRC idle state, or is in the RRC inactive state, it selects an appropriate cell for camping so that the network is aware of the approximate location of the UE 3 (although not necessarily on a cell level).

The base station 5 may be a base station 5 that is split between one or more distributed units (DUs) 50 and a central unit (CU) 60, with a CU 60 typically performing higher level functions and communication with the next generation core, and with the DU 50 performing lower level functions and communication over an air interface with UEs 3 in the vicinity (i.e. in a cell operated by the base station 5). This type of base station 5 may be referred to as a ‘distributed’ base station 5 or gNB 5. A distributed gNB 5 includes the following functional units: gNB Central Unit (gNB-CU): a logical node hosting Radio Resource Control (RRC), Service Data Adaptation Protocol (SDAP) and Packet Data Convergence Protocol (PDCP) layers of the gNB (or RRC and PDCP layers of an en-gNB) that controls the operation of one or more gNB-DUs. The gNB-CU terminates the so-called F1 interface connected with the gNB-DU.

gNB Distributed Unit (gNB-DU): a logical node hosting Radio Link Control (RLC), Medium Access Control (MAC) and Physical (PHY) layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.
gNB-CU-Control Plane (gNB-CU-CP): a logical node hosting the RRC and the control plane part of the PDCP protocol of the gNB-CU for an en-gNB or a gNB. The gNB-CU-CP terminates the so-called E1 interface connected with the gNB-CU-UP and the F1-C(F1 control plane) interface connected with the gNB-DU. gNB-CU-User Plane (gNB-CU-UP): a logical node hosting the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U (F1 user plane) interface connected with the gNB-DU.

It will be appreciated that when a distributed base station or a similar control plane-user plane (CP-UP) split is employed, the control-plane and user-plane entities may each include an associated transceiver circuit, antenna, network interface, controller, memory, operating system, and communications control module. When the base station 5 comprises a distributed base station, the network interface also includes an E1 interface and an F1 interface (F1-C for the control plane and F1-U for the user plane) to communicate signals between respective functions of the distributed base station.

### Frame Structure

Referring to FIG. 2, which illustrates a typical frame structure that may be used in the communication system 1, the base station 5 and UEs 3 of the communication system 1 communicate with one another using resources that are organised, in the time domain, into frames of length 10 ms. Each frame comprises ten equally sized subframes of 1 ms length. Each subframe is divided into one or more slots comprising 14 Orthogonal frequency-division multiplexing (OFDM) symbols of equal length.

As seen in FIG. 2, the communication system 1 supports multiple different numerologies (subcarrier spacing (SCS), slot lengths and hence OFDM symbol lengths). Specifically, each numerology is identified by a parameter, μ, where μ=0 represents 15 kHz (corresponding to the LTE SCS). Currently, the SCS for other values of μ can, in effect, be derived from μ=0 by scaling up in powers of 2 (i.e. SCS=15×2 μ kHz). The relationship between the parameter, μ, and SCS (Δf) is as shown in Table 1:

TABLE 1
5G Numerology

| | Δf = 2^{μ} · | Number of slots | Slot |
|---|---|---|---|
| μ | 15[kHz | per subframe | length (ms) |
| 0 | 15 | 1 | 1 |
| 1 | 30 | 2 | 0.5 |
| 2 | 60 | 4 | 0.25 |
| 3 | 120 | 8 | 0.125 |
| 4 | 240 | 16 | 0.0625 |

### (R)AN Node

### DU

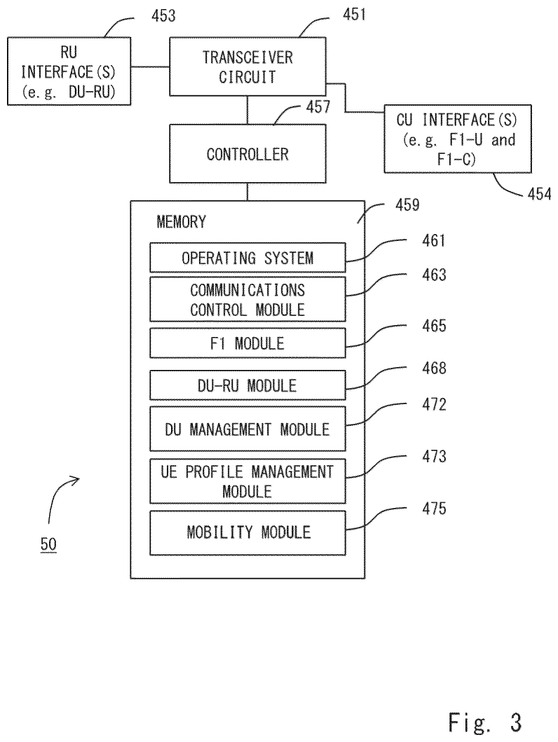

FIG. 3 is a schematic block diagram illustrating the main components of a DU 50 that may be used as part of the (R)AN node 5 for the communication system 1 shown in FIG. 1. As shown, the DU 50 has a transceiver circuit 451 for: transmitting signals to, and for receiving signals from, the communication devices (such as UEs 3) via the radio unit (RU) and the associated DU-RU interface 453; and for transmitting signals to, and for receiving signals from, the CU 60 of the (R)AN node 5 via a CU interface 454 (e.g. comprising an F1 interface which may be split into an F1-U and an F1-C interface for user plane and control plane signalling respectively).

The DU 50 has a controller 457 for controlling the operation of the DU 50. The controller 457 is associated with a memory 459. Software may be pre-installed in the memory 459 and/or may be downloaded via the communications network 1 or from a removable data storage device (RMD) for example. The controller 457 is configured to control the overall operation of the DU 50 by, in this example, program instructions or software instructions stored within memory 459.

As shown, these software instructions include, among other things, an operating system 461, a communications control module 463, an F1 module 465, a DU-RU module 468, a DU management module 472, a UE profile management module 473 and a mobility module 475.

The communications control module 463 is operable to control the communication between the DU 50 and one or more RUs (and hence between the DU 50 and the UE 3), and between the DU 50 and the CU 60. The communications control module 463 is configured for the overall control of the reception of signals corresponding to uplink communications from the UE 3 and for handling the transmission of downlink communications to the UE 3.

The F1 module 465 is responsible for the appropriate processing of signals received from, or transmitted to, the CU 60 via one or more CU (e.g. F1) interfaces 454. These signals may be separated into: user plane signals received from, or transmitted to, the CU-UP part of the CU 60 via the F1-U interface; and control plane signals received from, or transmitted to, the CU-CP part of the CU 60 via the F1-C interface.

The DU-RU module 468 is responsible for the appropriate processing of signals received from, or transmitted to, the RU via one or more RU (e.g. DU-RU) interfaces 453.

The DU management module 472 is responsible for managing the overall operation of the DU 50 and the overall performance of the tasks required of the DU 50. These tasks include, among other things, the generation and transmission of appropriate messages using appropriate signalling application protocols, depending on the functional split between the RU, DU 50 and CU 60, such as interpretation of received MAC signalling and the generation of MAC signalling for transmission. The DU management module 472 may control the overall operation of the DU 50 in accordance with any of the methods describe below, where appropriate.

The UE profile management module 473 is responsible for carrying out functions related to the UE profile including (where applicable): the reception and storage of the UE profile or related assistance/preference information from the UE 3 or from elsewhere in the network; the determination (where applicable) of appropriate mobility specific configurations, based on the UE profile/assistance information/preference information, for implementation at the UE 3 and/or RAN equipment; and/or the provision of configuration information (where applicable) for configuring the UE appropriately with mobility based configurations. The UE profile management module 473 may also store, for example, previous mobility information for a UE 3 (e.g. previous movements of the UE 3 between different communication cells of the network). It will be appreciated that, depending on implementation, the gNB-DU may not implement at least some of these features.

The mobility module 475 is responsible for controlling mobility procedures for one or more UEs 3. For example, the mobility module 475 may be configured to perform one or more measurements for UE 3 mobility, or to select a candidate cell for handover, in accordance with any of the methods described below.

### CU

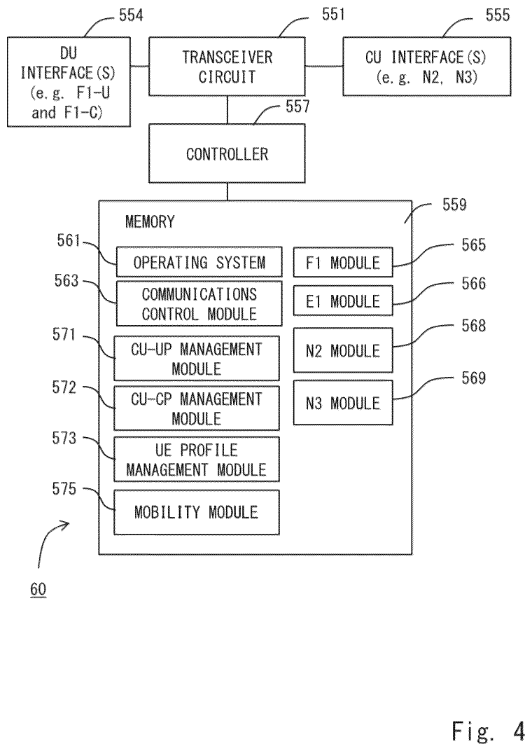

FIG. 4 is a schematic block diagram illustrating the main components of the CU 60 of the RAN equipment for the communication system 1 shown in FIG. 1. As shown, the CU 60 has a transceiver circuit 551 for: transmitting signals to, and for receiving signals from, the DU 50 via one or more DU interfaces 554 (e.g. comprising an F1 interface which may be split into an F1-U and an F1-C interface for user plane and control plane signalling respectively); and for transmitting signals to, and for receiving signals from, the functions of the core network 7 via one or more core network interfaces 555 (e.g. comprising the N2 and N3 interfaces or the like).

The CU 60 has a controller 557 to control the operation of the CU 60. The controller 557 is associated with a memory 559. Software may be pre-installed in the memory 559 and/or may be downloaded via the communications network 1 or from a removable data storage device (RMD) for example. The controller 557 is configured to control the overall operation of the CU 60 by, in this example, program instructions or software instructions stored within memory 559.

As shown, these software instructions include, among other things, an operating system 561, a communications control module 563, an F1 module 565, an E1 module 566, an N2 module 568, an N3 module 569, a CU-UP management module 571, a CU-CP management module 572, a UE profile management module 573, and a mobility module 575. The functions of the mobility module 575 are the same as described above with reference to FIG. 3.

The communications control module 563 is operable to control the communication between the CU 60 and one or more DUs 50 (and hence between the CU 60 and the UE 3), and between the CU 60 and the core network 7. The communications control module 563 is configured for the overall control of the reception of signals corresponding to uplink communications from the UE 3 and for controlling the transmission of downlink communications.

The F1 module 565 is responsible for the appropriate processing of signals received from, or transmitted to, the DU 50 via one or more DU (e.g. F1) interfaces 554. These signals include: user plane signals received at, or transmitted by, the CU-UP part of the CU 60 via the F1-U interface; and control plane signals received at, or transmitted by, the CU-CP part of the CU 60 via the F1-C interface.

The E1 module 566 is responsible for the appropriate processing of signals transmitted between the CU-UP part of the CU 60 and the CU-CP part of the CU 60 via the corresponding internal CU interface (e.g. E1).

The N2 module 568 is responsible for the appropriate processing of signals received from, or transmitted to, the AMF 10-1 via one or more corresponding core network interfaces (e.g. N2) 555.

The N3 module 569 is responsible for the appropriate processing of signals received from, or transmitted to, one or more core network user plane functions via one or more corresponding core network interfaces (e.g. N3) 555.

The CU-UP management module 571 is responsible for managing the overall operation of the CU-UP part of the CU 60 and the overall performance of the tasks required of the CU-UP.

The CU-CP management module 572 is responsible for managing the overall operation of the CU-CP part of the CU 60 and the overall performance of the tasks required of the CU-CP. These tasks include, among other things, the generation and transmission of appropriate messages using appropriate signalling application protocols, depending on the functional split between the RU, DU 50 and CU 60, such as interpretation of received RRC signalling and the generation of RRC signalling for transmission.

The UE profile management module 573 is responsible for carrying out functions related to the UE (mobility) profile including (where applicable): the reception and storage of the UE profile or related assistance/preference information from the UE 3 or from elsewhere in the network; the determination of appropriate mobility specific configurations, based on the UE profile/assistance information/preference information, for implementation at the UE 3 and/or RAN equipment 5; and/or the provision of configuration information for configuring the UE appropriately with mobility based configurations. The UE profile management module 573 may also store previous mobility information for a UE 3 (e.g. previous movements of the UE 3 between different communication cells of the network). It will be appreciated that, depending on implementation, the CU 60 may not implement at least some of these features.

### System Information and SIB

It will be appreciated that transmissions in a cell 9 of a base station 5 may include one or more broadcast transmissions, one or more unicast transmissions for reception by a UE 3, and/or one or more multicast transmissions for reception by a group of UEs 3. System information (SI) transmitted in a cell may include ‘minimum SI’ (MSI) and ‘other SI’ (OSI). The OSI may be broadcast on-demand, for example using a downlink shared channel (DL-SCH). The OSI may be broadcast upon request from a UE 3 that is in a radio resource control (RRC) idle or RRC inactive state. The OSI may also be requested by a UE 3 that is in the RRC connected state, for example via one or more dedicated RRC transmissions.

The SI may include information for enabling (e.g. configuring) the UE 3 to complete a cell selection, may include information for enabling the UE 3 to complete a cell reselection procedure, or for enabling the UE 3 to receive one or more paging messages transmitted in a cell. SI may be broadcast using a Master Information Block (MIB) and one or more System Information Blocks (SIB).

The MSI comprises the MIB and system information block 1 (SIB1). The MIB includes information for use by the UE 3 to receive SIB1, for example a subcarrier spacing for SIB1. The MIB provides information corresponding to a Control Resource Set (CORESET) and Search Space. SIB1 may be referred to as ‘remaining MSI’ (RMSI). SIB1 may be transmitted in a dedicated RRC message, and other SIB (e.g. SIB2 to SIB9) may be transmitting using one or more other suitable RRC transmissions (e.g. another dedicated RRC message). The MIB and SIB1 may provide the UE 3 with an indication of scheduling information for receiving and decoding the other SIB, such as SIB2 to SIB9, and may provide information for use by the UE 3 to receive one or more paging messages. The OSI may comprise, for example, SIB2 to SIB9 transmitted using a DL-SCH in SI messages. A mapping of SIB2 to SIB9 to corresponding SI messages may be provided to the UE 3 by the base station 5. MIB and SIB1 to SIB9 are described in more detail, for example, in 3GPP TS 38.331. SIB2 provides information for intra-frequency, inter-frequency and inter-system cell reselection. SIB3 provides cell-specific information for intra-frequency cell reselection. SIB4 provides information for inter-frequency cell reselection. SIB5 provides information regarding inter-system cell reselection towards 4G (LTE). SIB6 and SIB7 provide information for an earthquake and tsunami warning system (ETWS). SIB8 provides information for a commercial mobile alert service (CMAS) notification, for example to provide warning text messages to the UE 3. SIB9 includes information regarding coordinated universal time (UTC), global positioning system (GPS) time (e.g. for GPS initialisation) and local time.

SIB may be broadcast periodically (e.g. according to a predetermined periodic pattern), or alternatively may be provided ‘on-demand’, for example in response to a request from a UE 3. For example, MIB may be transmitted with a periodicity of 80 ms and repetitions made within 80 ms, and SIB1 may be transmitted with a periodicity of 160 ms and a variable transmission repetition periodicity within 160 ms (e.g. 20 ms). SIB1 can be used to indicate to a UE 3 which SIB are transmitted periodically and which SIB are available on-demand in response to a request from the UE 3. A UE 3 may be configured to request on-demand SIB using message 1 (MSG1), which may be referred to as a MSG1-based on-demand SI request, or message 3 (MSG3), which may be referred to as a MSG3-based on-demand SI request.

A physical broadcast channel (PBCH) can be used to broadcast the MIB. The base station 5 may transmit the PBCH with synchronisation signals (SS) (e.g. primary synchronisation signal (PSS) and secondary synchronisation signal (SSS)) in a SS/PBCH Block. The SS/PBCH block comprises four orthogonal frequency-division multiplexed (OFDM) symbols that are mapped to PSS, SSS and PBCH associated with a demodulation reference signal (DM-RS). In the frequency domain, an SS/PBCH block comprises 240 contiguous subcarriers. When the UE 3 is in an RRC connected state, the base station 5 may provide the UE 3 with an indication of resources used for the SS/PBCH, for example using dedicated signalling. SIB1 may be transmitted using a physical downlink shared channel (PDSCH). The OSI may be similarly transmitted, for example, using a PDSCH. When one or more beamformed transmissions are transmitted in a cell provided by the base station 5, some of the SI (e.g. some of the SIB) may only be transmitted using particular beams, or using a particular transmission/reception point (TRP).

### UE Mobility

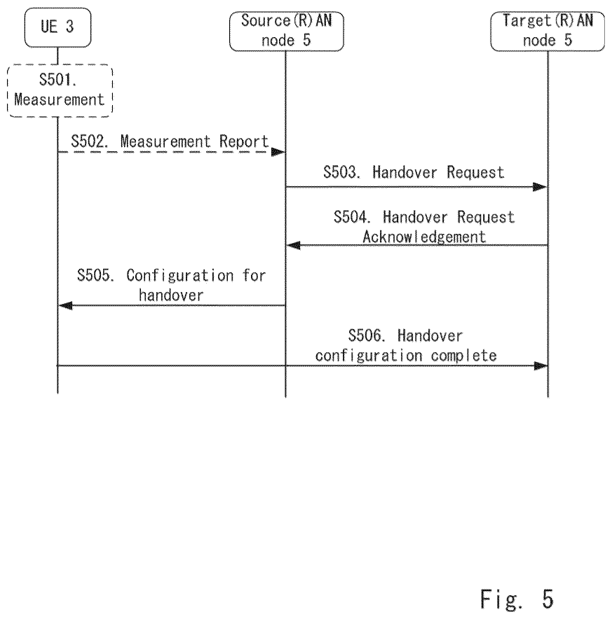

FIG. 5 shows an overview of a mobility procedure that may be performed in a communication system 1 of the type illustrated in FIG. 1. In this example, a handover of a UE 3 from a source base station 5 to a target base station 5 is performed.

In optional step S501 the UE 3 performs a measurement. The measurement may be a measurement of a signal transmitted by the source base station 5 or a measurement of a signal transmitted by the target base station 5. The measurement may be a measurement of a signal strength, that can be used as part of a determination that the UE 3 is to be handed over from the source base station 5 to the target base station 5. In optional step S502 the UE 3 transmits a measurement report to the source base station 5 that provides an indication of the result of the measurement. The measurement report may be transmitted from the UE 3 to the source base station 5 in an RRC message. In this example the source base station 5 uses the information provided in the measurement report to determine that the UE 3 is to be handed over to the target base station 5. However, it will be appreciated that a determination that handover to the target base station 5 is to be performed may alternatively (or additionally) be based on a measurement performed at the source base station 5 or at the target base station 5. Alternatively, a determination that handover of the UE 3 is to be performed may be based on a factor other than a signal measurement, such as a level of congestion in a cell operated by the source base station 5.

In Step S503 the source base station 5 transmits a handover request to the target base station 5, requesting handover of the UE 3 from the source base station 5 to the target base station 5. The handover request may include an indication of, for example, an identity of the source base station 5, a cause value for the handover, an identity of the target cell, UE 3 context information (e.g. a maximum bit rate of the UE 3, or security capabilities of the UE 3), and UE history information. If the handover has been triggered by the measurement report received by the source base station 5 in step S502, then the cause value may indicate, for example, that the handover is desirable for radio reasons. Alternatively, if the handover has been triggered to reduce the load at the source base station 5, the cause value may indicate that the handover is for reducing load in the serving cell. The handover request message may also include an indication of the AMF 10-1 that is serving the UE 3.

In step S504, the target base station 5 transmits an acknowledgement of the handover request (which may be referred to as a “handover request acknowledgement” message). The handover request acknowledgement message includes an indication of handover configuration information for the handover that is to be forwarded to the UE 3. The handover request acknowledgement message may also include configuration information that enables the source base station 5 to begin forwarding user plane data for the UE 3 to the target base station 5.

The transmissions of steps S503 and S504 may be performed over an Xn interface between the source base station 5 and the target base station 5 (and therefore the handover procedure in this example may be referred to as an Xn-based handover procedure). Steps S501 to S504 may be referred to as a ‘handover preparation phase’.

In step S505, the source base station 5 transmits the handover configuration information to the UE 3. The configuration information for the handover may be, for example, an RRC configuration transmitted in an RRC configuration message or an RRC reconfiguration message. In step S506, the UE 3 applies the received configuration for handover and transmits an indication to the target base station 5 that configuration for the handover is complete. The message transmitted in step S505 may be, for example, an RRC Reconfiguration Complete message. Steps S505 and S506 may be referred to as a ‘handover execution phase’.

Following the handover execution phase, the UE 3 is operable to transmit uplink transmissions to the target base station 5 (e.g. uplink data) and receive downlink transmissions from the target base station 5 (e.g. downlink data).

It will be appreciated that mobility methods and handover procedures for the UE 3 are not restricted to the example illustrated in FIG. 5. For example, the UE 3 may be configured to perform a conditional handover (CHO) in which the UE 3 determines whether handover of the UE 3 to a candidate cell is to be performed based on one or more execution conditions. It will also be appreciated that handover may be performed in which the DU 50 changes but the CU 60 remains the same (inter-DU intra-CU handover), in which both the DU 50 and CU 60 change (inter-DU inter-CU handover), or between two cells operated by the same DU 50.

### Random Access

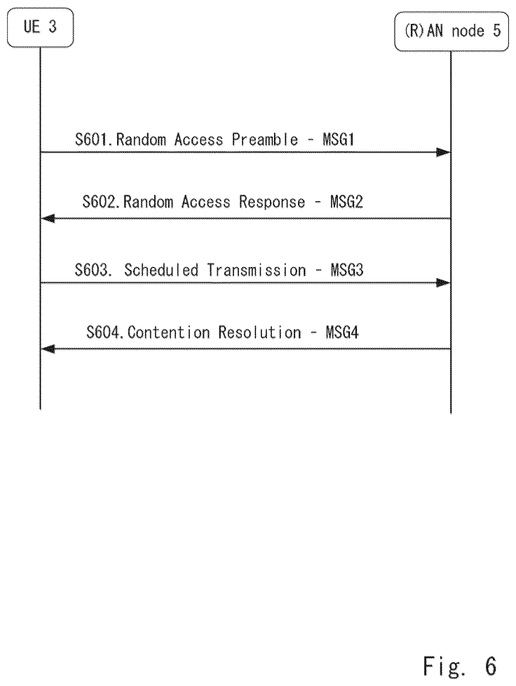

FIG. 6 shows a random access (RA) procedure that may be performed in the system of FIG. 1. The RA procedure can be used, for example, for initial access by a UE 3 that is in the RRC idle mode, or for a transition from the RRC inactive mode to the RRC connected mode. The RA procedure may also be used during handover of the UE 3 from a source base station to a target base station (e.g. the handover procedure described above with reference to FIG. 5), for initial access to the target base station 5.

In step S601 the UE 3 transmits a random access preamble to the base station 5. In this example the UE 3 selects the random access preamble to transmit from a group of random access preambles that are shared with other UEs 3. The transmission of step S601 may be referred to as message 1 (MSG1), and is transmitted using PRACH.

In step S602 the base station 5 transmits a random access response to the UE 3. The transmission of step S602 may be referred to as message 2 (MSG2). The random access response indicates time and/or frequency resources (e.g. resource blocks and/or symbols) for use by the UE 3 to transmit a subsequent transmission to the base station 5. The random access response may also include further information for use by the UE 3 for communication with the base station 5, such as a timing advance (TA) value.

In step S603 the UE 3 transmits a transmission to the base station 5 using the indicated time and/or frequency resources. The transmission of step S603 may be referred to as message 3 (MSG3). The transmission of step S603 may be a layer 2 (L2) or layer 3 (L3) message. The transmission of step S603 may comprise, for example, an RRC setup request, an RRC resume request, an RRC reestablishment request, or an RRC reconfiguration complete message.

If two UEs 3 selected and transmitted the same random access preamble in step S601, and receive and decode MSG2 transmitted by the base station 5 in step S602, then the two UEs may transmit MSG3 using the same time and/or frequency resources. This situation can be referred to as ‘contention’ or ‘collision’. In order to resolve the contention, in step S604 the base station 5 transmits a content resolution message to the UE 3. The transmission of step S604 may be referred to as message 4 (MSG4). MSG4 indicates to the UE 3 whether the MSG3 transmitted by the UE 3 in step S603 was received and successfully decoded by the base station. MSG3 transmitted in step S603 may not have been received or successfully decoded by the base station 5 if the base station 5 decoded a MSG3 transmitted by another UE 3 that is in contention with the UE 3, or if interference occurred between the MSG3 transmitted by the two UEs 3. If MSG3 transmitted by the UE 3 was not decoded by the base station 5 (which the UE 3 may determine if the UE 3 does not receive MSG4 from the base station 5), then the UE 3 returns to step S601 of the method and transmits another MSG1 to the base station 5 (e.g. after selecting a different random access preamble).

The procedure illustrated in FIG. 6 is an example of a contention based RA procedure in which the UE 3 selects the random access preamble from a group of preambles that could also be used by other UEs 3 (and therefore contention can occur if two of the UEs 3 select the same random access preamble). Alternatively, the base station 5 may transmit a random access preamble assignment to the UE 3 before the UE 3 transmits MSG 1 to the base station 5, in which case the RA procedure is contention free (and the contention resolution in step S604 need not be performed). The random access preamble assignment may be transmitted to the UE 3 using an RRC message or layer 1 (L1) signalling (e.g. using DCI carried by a PDCCH). In the method illustrated in FIG. 5, a random access preamble assignment for communication with the target base station 5 may be transmitted to the UE 3 in step S505.

MSG1 and/or MSG 3 may be used by the UE 3 to request on-demand SI from the base station 5.

### Lower-layer Mobility Procedures

When UE 3 moves from one cell to another, a serving cell may need to be changed. Serving cell change may be triggered by layer 3 (L3) measurements and can be achieved using radio resource control (RRC) signalling. However, this process involves layer 1 (L1) and layer 2 (L2) resets, resulting in increased latency, larger overhead and longer interruption time. For inter-cell mobility the UE may need to perform reconfiguration and downlink/uplink (DL/UL) synchronisation towards the target cell. In order to enable more efficient handover, lower-layer based (L1 or L2) handover may be used. Beneficially, the UE 3 and base station can be configured for implementing an intra-CU LTM procedure in which the UE 3 is able to switch between pre-configured candidate lower-layer triggered mobility (LTM) cells, based on the content of lower layer (L1 and/or L2) measurement reports, relatively swiftly (e.g., potentially without requiring any RRC reconfiguration). Accordingly, as the UE 3 moves around the pre-configured candidate LTM cells, it can execute fast cell switches, potentially without RRC reconfiguration.

### Conditional Handover (CHO)

Conditional Handover (CHO) is a handover that is executed by the UE 3 when one or more handover execution conditions are met. The UE 3 starts evaluating one or more execution conditions upon receiving a CHO configuration (from the network, e.g. from the base station 5), and stops evaluating one or more execution conditions once the handover is executed. The execution conditions may be based, for example, on measurements performed by the UE 3 of reference signal received power (RSRP), reference signal received quality (RSRQ), RSRP and signal to noise interference ratio (RSRP-SINR). For layer 1/layer 2 (L1/L2) mobility, handover is initiated based on L1/L2 measurement results.

An example of CHO will now be described. A ‘CHO candidate cell’ is a candidate cell for CHO, and has a corresponding CHO configuration. The CHO configuration comprises the configuration of one or more CHO candidate cells generated by the candidate base stations 5 and one or more execution conditions generated by the source base station 5.

An execution condition may comprise, for example, one or two trigger conditions, which may also be referred to as CHO events.

As in intra-NR RAN handover, in intra-NR RAN CHO, the preparation and execution phase of the conditional handover procedure may be performed without involvement of the core network; i.e. preparation messages are directly exchanged between base stations 5. The release of the resources at the source base station during the conditional handover completion phase is triggered by the target base station 5.

In a CHO method, the source base station 5 may determine that CHO should be used. The source base station 5 may request CHO for one or more candidate cells belonging to one or more candidate base stations 5. A CHO request message can then be sent for each candidate cell.

The candidate base stations 5 send a CHO response, including a configuration of one or more CHO candidate cells, to the source base station 5. The CHO response message may be sent for each candidate cell.

The source base station 5 may send an RRC Reconfiguration message to the UE 3, containing the configuration of one or more CHO candidate cells and one or more CHO execution conditions.

The UE 3 may send an RRC Reconfiguration Complete message to the source base station 5.

If early data forwarding is applied, the source base station 5 may sends an early status transfer message.

The UE 3 maintains connection with the source base station after receiving CHO configuration, and starts evaluating the CHO execution conditions for one or more candidate cells. If at least one CHO candidate cell satisfies the corresponding CHO execution condition, the UE 3 detaches from the source base station, applies the stored corresponding configuration for that selected candidate cell, synchronises to that candidate cell and completes the RRC handover procedure by sending an RRC Reconfiguration Complete message to the target base station 5. The UE 3 releases stored CHO configurations after successful completion of the handover procedure.

A target base station 5 sends the handover success message to the source base station 5 to inform that the UE 3 has successfully accessed the target cell. In return, the source base station 5 sends a sequence number status transfer (e.g. SN STATUS TRANSFER) message.

The source base station 5 can then send a handover cancel message toward the other signalling connections or other candidate target base stations, if any, to cancel CHO for the UE 3.

Conditional configurations for a conditional handover may be provided as a ‘delta configuration’ with respect to the configuration of the serving cell. In other words, parameters and setting for the conditional configuration may be indicated by indicating the differences between the conditional configuration and the configuration of the serving cell.

A UE 3 may be configured to indicate to another entity in the network 1 that the UE 3 supports conditional handover by, for example, transmitting a signal that includes an indication in a conditional handover field or information element.

A CHO candidate cell list can be used to indicate a list of candidate target cells for a conditional handover. A candidate target cell for CHO may be referred to as a CHO candidate. For example, up to 8 candidate cells with associated conditional handover execution conditions may be configured for a UE 3. The number of execution conditions may be two (alternatively one execution condition, or three or more execution conditions, could conceivably be used). The UE 3 executes the CHO towards a selected target cell when the conditions are met by applying the corresponding conditional reconfigurations. This improves mobility robustness since the CHO configuration can be sent before the serving cell quality drops, and the UE 3 may avoid mobility failure due to a missed HO command.

Intra-CU inter-DU mobility

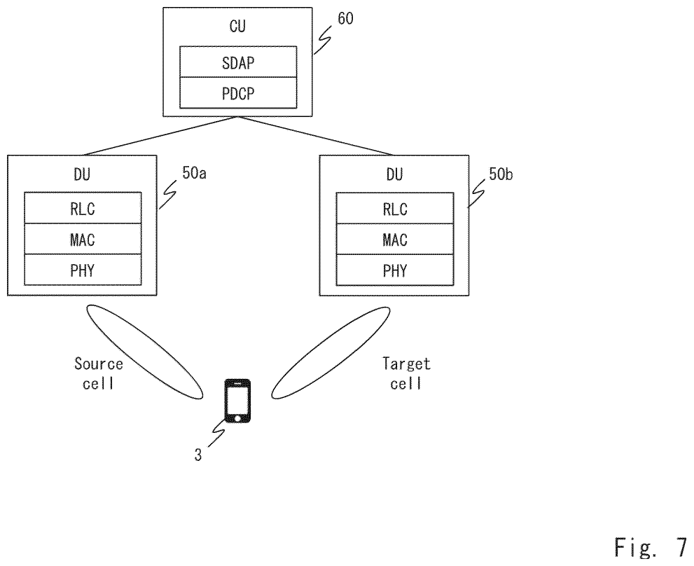

FIG. 7 shows an example of Intra-CU inter-DU mobility.

In this case, the current serving cell and the candidate cells share the same CU. Since the source cell and the target cell are provided by a different DU, radio link control (RLC) layer is re-established, and the medium access control (MAC) layer is reset.

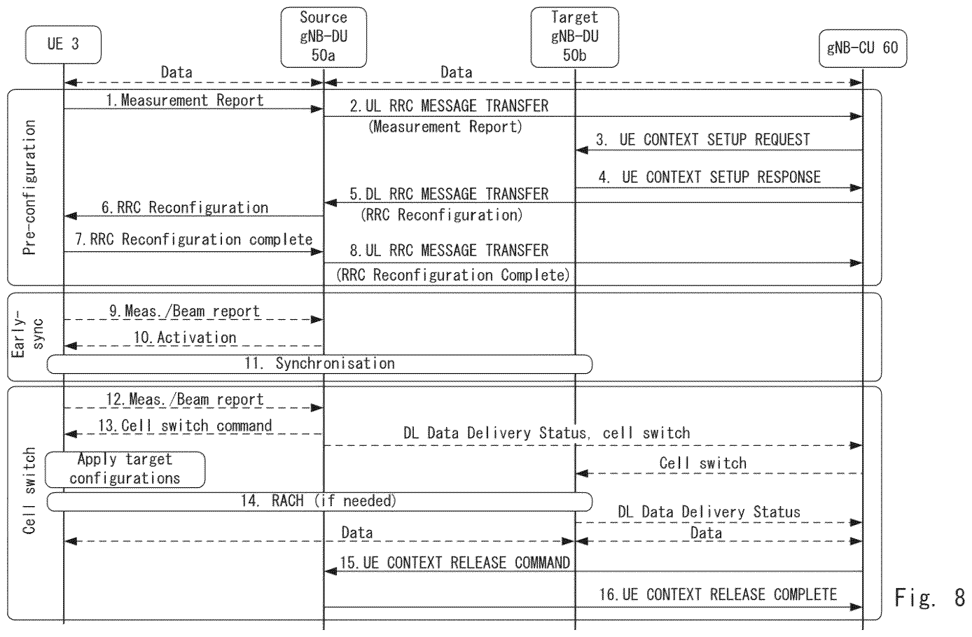

FIG. 8 illustrates an exemplary method of inter-DU mobility. A procedure for L1/L2-based inter-cell mobility from a source DU 50a to a target DU 50b is shown. As shown in the figure, the method comprises a pre-configuration stage, an early-synchronisation stage, and a cell switch stage, described below.

Prior to the LTM procedure being triggered, the UE 3 is communicating user data via the source DU 50a and associated CU 60.

### Pre-Configuration

The UE 3, source DU 50a, and associated CU 60 engage in an L3 measurement control and reporting procedure in the pre-configuration state. This procedure typically involves the UE 3 sending, to the source DU 50a, an L3 (e.g. RRC) measurement report (e.g., in a ‘MeasurementReport’ message or the like) containing the results of measurements for one or more cells (e.g., of measurements of reference signals in a serving cell and/or one or more neighbouring cells). The measurement results may include, for example, L3 filtered measurement results for a beam and/or cell (but this need not be the case). The source DU 50a may then send an appropriate message (e.g., UL RRC Message Transfer message, as illustrated in FIG. 8, or the like) for conveying the received measurement report to the CU 60.

In steps 1 and 2 the UE 3 sends a layer 3 (L3) measurement report to the source DU 50a based on measurement configurations. The measurement report is forwarded to CU 60.

In steps 3 to 8 the CU 60 determines a candidate set for UE 3, sends a preparation request to the target DU 50b and receives a corresponding acknowledgement from target DU 50b. Then CU 60 sends the RRC reconfiguration to UE 3 and receives a corresponding RRC reconfiguration complete message, via source the DU 50a.

In other words, the CU 60 sends one or more messages for requesting the setting up a context for the UE 3 (e.g., a UE Context Setup Request as shown in step 3 of FIG. 8, or the like) to one or more candidate DUs containing (candidate) target cells. This message is, in effect, a request for LTM configuration at the recipient DU. If a candidate DU accepts the request for LTM configuration in one or more (candidate) target cells, it responds to the CU 60 with an appropriate response message (e.g., a UE Context Setup Response as shown in step 4 FIG. 8, or the like) including a generated lower layer RRC configuration for one or more accepted target candidate cells. It will be appreciated that, potentially, either a single or multiple UE context setup procedures may be used at this stage. In the illustrated procedure the target DU 50b performs LTM candidate cell preparation, and responds with a response message including the generated lower layer RRC configuration for one or more accepted target candidate cells of the target DU 50b.

The CU 60 sends, an appropriate message to the source DU 50b which includes a generated RRC reconfiguration message with the L1/L2 triggered mobility configuration. This message may, for example, be a UE Context Modification Request or another message such as, for example, a DL RRC Message Transfer message as illustrated in step 5 of FIG. 8, or the like. The source DU 50a forwards, in step 6 of FIG. 8, the received RRC reconfiguration message to the UE 3. The RRC reconfiguration message includes LTM candidate cell configurations, including the corresponding cell Radio Network Temporary Identifiers (C-RNTI). The UE 3 responds, in step 7 of FIG. 8, with an RRC reconfiguration complete message.

The source DU 50a forwards, in step 8 of FIG. 8, the RRC reconfiguration complete message to the CU 60 using an appropriate message. This message may, for example, be a UE Context Modification Response, or another message such as, for example, an UL RRC Message Transfer message as illustrated in FIG. 8, or the like.

### Early Synchronisation

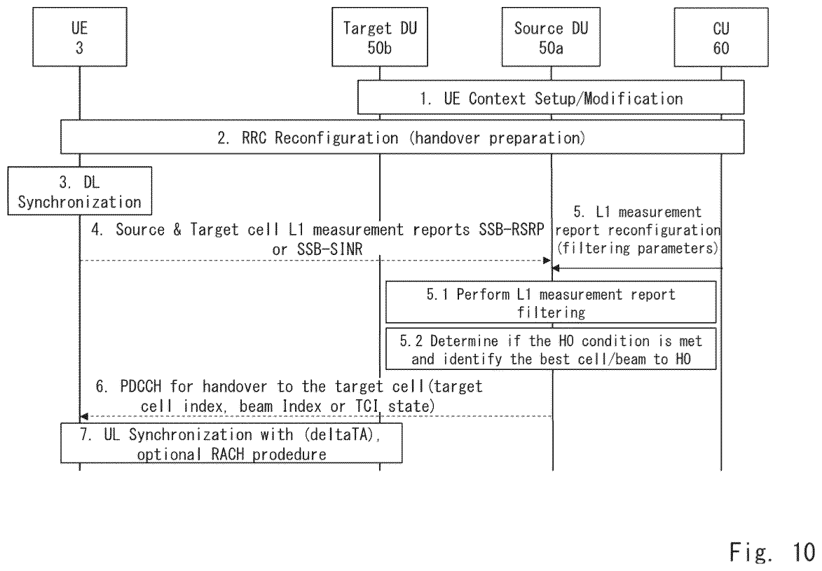

In optional steps 9 to 11 the UE 3 performs L1 measurements and reports for reference signals (e.g. SSB or CSI-RS illustrated in FIG. 10) corresponding to inter-cell beams, based on configurations from the network. Based on L1 measurement reports, the network 1 may activate some transmission configuration information (TCI) states quasi co-located (QCL-ed) with cells whose physical cell ID (PCI) is different from serving cell. The UE 3 performs synchronisation (DL and optionally UL) for these cells.

### Cell Switch

Following the LTM pre-configuration and Early-sync, the UE 3 and base station 5 may engage in an LTM cell switch procedure as shown in FIG. 8, to switch to a cell of the target DU 50b. After the UE 3 accesses the new cell of the target DU 50b, and the target DU 50b detects that access, the target DU 50b can notify the CU 60 of the access success. The UE 3 can then communicate user data via the target DU 50b and the associated CU 60.

In steps 12 to 13 of FIG. 8, based on further L1 reports, the DU 50 may indicate a target cell and beam (TCI state). The UE 3 applies target cell configurations. In step 14, if timing advance (TA) is not available, the UE 3 may perform a random access channel (RACH) procedure for the indicated target cell. In steps 15 and 16 the UE 3 receives PDCCH from target cell using new TCI state.

The UE 3 may send a lower layer measurement report (e.g., including one or more L1/L2 measurement results) to the source DU 50a (e.g., for the serving and/or one or more target/candidate cells) in step 12 of FIG. 8.

The source DU 50a then determines to execute LTM to switch to a candidate target cell. In other words, the source DU 50a makes an LTM handover decision. It will be appreciated that the DU 50a may also notify the LTM cell switch decision to the other nodes as well. The source DU 50a sends, in step 13 of FIG. 8, an LTM cell switch command to the UE 3. It will be appreciated that the decision to switch to a particular candidate target cell (and any notification of the LTM cell switch decision to other nodes) may occur after the source DU 50a sends, in step 13, the LTM cell switch command to the UE 3 (e.g., using a MAC control element (CE) or the like).

The UE 3 is thus able to detach from the current cell of the source DU 50a (and synchronise to the target cell of the target DU 50b as necessary). The UE 3 may then engage, in step 14, in a random access channel (RACH) based initial access procedure, or a RACH-less initial access procedure with the target DU 50b.

The source DU 50a may also notify the CU 60 about the initiation of LTM/the sending of the LTM command to the UE 3 (e.g., over the F1 interface using an F1 application protocol (F1AP) or the like). The notification may be sent in parallel with (or even after) the UE 3 detaching from the current cell of the source DU 50a/synchronising to the target cell of the target DU 50b. The target DU 50b detects the UE access and can notify the CU 60 of the access success. The UE 3 can then communicate user data via the target DU 50b and associated CU 60 (as illustrated in FIG. 8).

It will be appreciated that, as a skilled person would understand, for inter-DU LTM, any release of resources of the source cell (and any prepared cell) in the source DU 50a, may be achieved in any appropriate manner (if at all).

It will be appreciated that the detailed steps of the procedures described with reference to FIG. 8 are exemplary and provided, for illustrative purposes, to how the procedures may be implemented. As those skilled in the art will be aware, there are a number of variations to the procedure and, in particular to the LTM pre-configuration part and/or the LTM cell switch part of the procedures.

### Inter-Cell Inter-DU

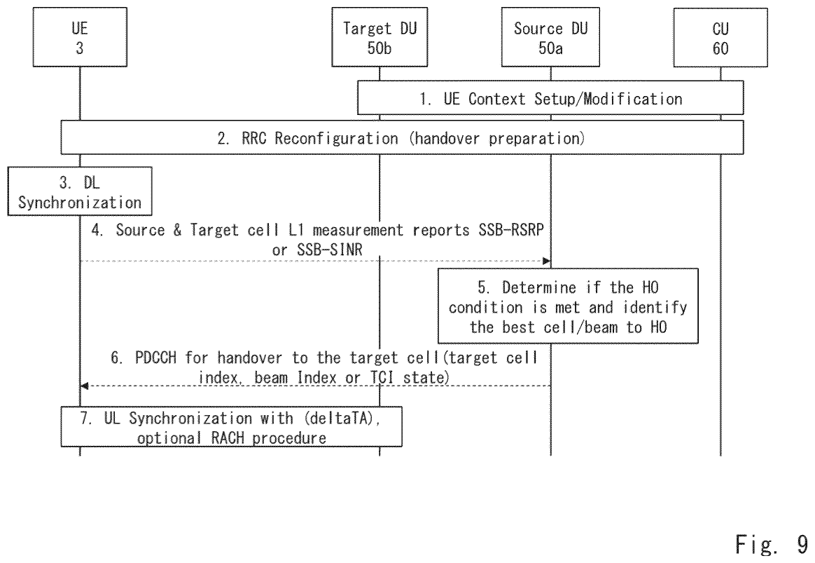

FIG. 9 shows an inter-cell inter-DU method.
In step 1, UE Context Setup/Modification is performed (e.g. in which the CU transmits a UE context/setup modification request message to the target DU).
In step 2, RRC Reconfiguration (handover preparation) is performed.
In step 3, DL Synchronization is performed.
In step 4, Source & Target cell L1 measurement reports SSB-RSRP or SSB-SINR are transmitted from the UE 3 to the source DU 50a.
In step 5, a determination of whether the HO condition is met is performed, and the best cell/beam for HO is identified.
In step 6, a physical downlink control channel (PDCCH) for handover to the target cell (which may include a target cell index, beam Index or TCI state) is transmitted from the source DU 50a to the UE 3.
Step 7 comprises UL Synchronization (which may include transmission of timing advance information, described below), and an optional RACH procedure.
   BASE station triggered L1 mobility

FIG. 10 shows a base station triggered L1 mobility method including measurement report filtering.
Steps 1 to 4 of FIG. 10 correspond to steps 1 to 4 of FIG. 9.
In step 5, an L1 measurement report reconfiguration (which may include one or more filtering parameters) is transmitted from the CU 60 to the source DU 50a.
In step 5.1, L1 measurement report filtering is performed at the source DU 50a.
Step 5.2 of FIG. 10 corresponds to step 5 of FIG. 9.
Steps 6 and 7 of FIG. 10 correspond to steps 6 and 7 of FIG. 9.

### Handover Failure (HOF)

As part of a handover procedure, the UE 3 may start a timer (e.g., T304) upon receiving a handover command (i.e., reconfiguration WithSync) carried by a RRCReconfiguration message from a base station 5. The UE 3 attempts to access to the target cell following the handover command. However, if the UE 3 cannot successfully access to the target cell before the expiry of the timer, the UE 3 may experience handover failure. As a fallback to handle the handover failure, in case of timer expiry, the UE 3 performs cell reselection, and initiates an RRC re-establishment procedure to a reselected cell and try to recover the connection with the network.

### Radio Link Monitoring (RLM) and Radio Link Failure (RLF)

The UE 3 may be configured to perform one or more radio link monitoring (RLM) procedures to monitor a radio link for communications via a primary serving cell (PCell) of a master cell group (MCG). If a secondary cell group (SCG) is configured for the UE 3, then the UE 3 may also use the RLM procedures for communications via primary SCG cell (PSCell).

The UE 3 performs measurements for the RLM using the physical layer. The UE 3 performs the measurements to monitor the status of serving cell, and may also perform measurements for candidate cells for lower-layer triggered mobility. The measurement results may be passed to both the MAC and RRC layers at the UE 3. Radio link failure (RLF) can be detected using the measurements and the RRC layer. In other words, the RRC layer evaluates conditions for RLF based on the measurements performed by the UE 3. If it is determined that RLF has occurred, then corresponding RLF procedures are triggered, and RRC Re-establishment may be triggered. Configuration information for beam failure, and beam failure recovery parameters, may also be passed to the MAC layer from the RRC layer. Configuration information for the UE 3 measurements may be passed from the RRC layer to the physical layer, for example a set of radio link monitoring reference signal resources (RLM-RS) may be provided. The RLM-RS may comprise one or more SS/PBCH Blocks (SSB), and/or one or more channel state information reference signals (CSI-RS).

RLF may occur, for example, due to congestion in a cell of a base station 5, or due to a change in radio conditions (e.g. poor weather, or an obstruction between the UE 3 and the base station 5). In response to detecting RLF, the UE 3 may cease to transmit one or more uplink transmissions to avoid generating uplink interference (e.g. within 40 ms of detecting RLF).

The UE 3 is configured to generate a first indication (also referred to as an Out-of-sync indication) when the radio link quality of all monitored reference signals for a cell is worse than a first threshold quality (e.g. corresponding to a block error rate (BLER)). Similarly, the UE 3 is configured to generate a second indication (also referred to as an In-sync indication) when the radio link quality for at least one of the monitored reference signals for the cell is better than a second threshold quality. The Out-of-sync indications and the In-sync indications are forwarded to the RRC layer. The RRC layer uses the indications to determine whether RLF has occurred. An RLF timer is started when the RRC layer receives a predetermined number of Out-of-sync indications. This timer may be referred to as ‘T310’, and the predetermined number of Out-of-sync indications may be referred to as ‘N310’. The RLF timer is stopped if the RRC layer receives a predetermined number of In-sync indications. The predetermined number of In-sync indications may be referred to as ‘N311’. If the RLF timer expires before the RRC layer receives the predetermines number of In-sync indications, then the UE 3 determines that RLF has occurred. The values of the RLF timer, the predetermined number of Out-of-sync indications, and the predetermined number of In-sync indications may be configured by the network (e.g. transmitted to the UE 3 by the base station 5). If the reference signals received by the UE 3 are measured to have a quality in between the first threshold quality and the second threshold quality, then the UE 3 may not generate either the Out-of-sync indication or the In-sync indication for a particular measurement and evaluation period.

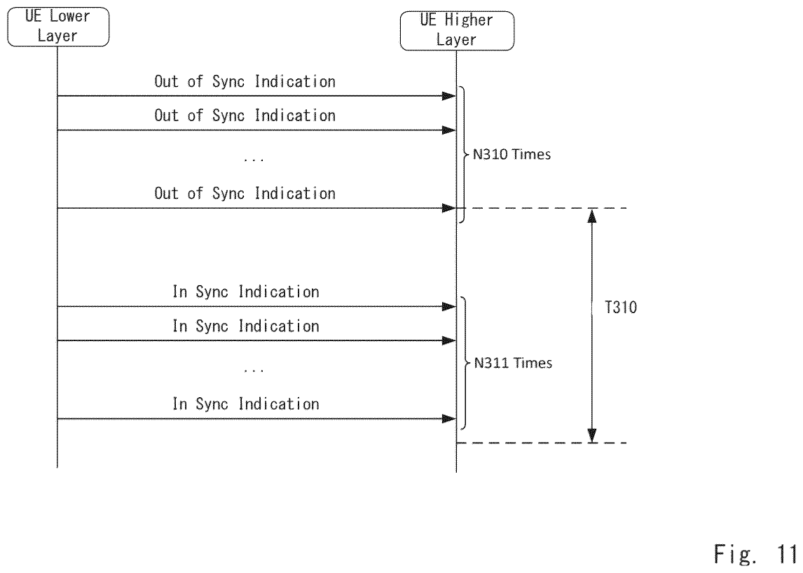

FIG. 11 illustrates a method in which radio link recovery occurs. As shown in FIG. 11, the RRC layer receives the predetermined number (N310) of Out-of-sync indications from the lower layer. Therefore, the RLF timer (T310) is started. In this example, the RRC layer receives the predetermined number (N311) of In-sync indications before the expiry of the RLF timer, and therefore the UE 3 determines that RLF has not occurred (in other words, radio link recovery has occurred).

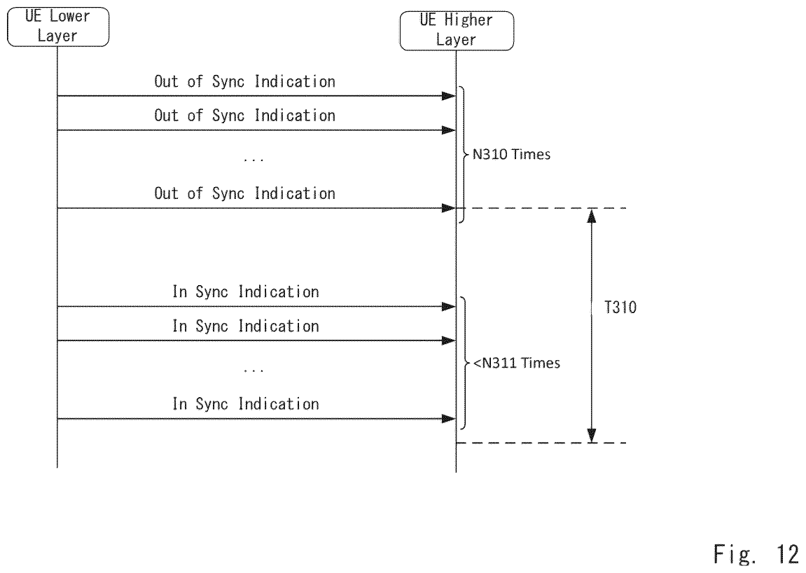

FIG. 12 illustrates a method in which radio link failure is determined. As shown in FIG. 12, the RRC layer receives the predetermined number (N310) of Out-of-sync indications from the lower layer. Therefore, the RLF timer (T310) is started. In this example, the RRC layer receives less than the predetermined number (N311) of In-sync indications before the expiry of the RLF timer, and therefore the UE 3 determines that RLF has occurred.

The UE 3 may also be configured to determine that RLF has occurred based on a number of re-transmissions (e.g. RLC re-transmissions) exceeding a threshold value. Alternatively, for example, the UE 3 may determine that RLF has occurred based on a number of preamble transmissions (or re-transmissions) during a RA procedure exceeding a threshold value.

Following detection of RLF at the primary serving cell, the UE may initiate an RRC connection re-establishment procedure, which may include a random access procedure. Following detection of RLF at the PSCell, the UE 3 may provide an indication of the RLF failure via a cell of the MCG (e.g. by transmitting SCG Failure Information) to the corresponding RAN node.

When the UE 3 is in an RRC connected state, the UE 3 may perform RLM in the active bandwidth part (BWP) based on reference signals (SSB/CSI-RS) and the signal quality thresholds configured by the network. SSB-based RLM is based on the SSB associated to the initial DL BWP and can be configured for the initial DL BWP and for DL BWPs containing the SSB associated to the initial DL BWP. After RLF is determined, the UE 3 may remain in the RRC connected state.

If RLF is determined for a target cell of a handover, the UE 3 may select a suitable cell and then initiate an RRC re-establishment procedure. The UE 3 may enter the RRC idle state if a suitable cell is not found within a certain time after the RLF is determined. For the case of conditional handover and RLF in the source cell, the UE 3 may be configured to select a suitable target candidate cell and attempt CHO execution. Otherwise, an RRC re-establishment procedure may be performed.

### Timing Advance (TA)

The UE 3 may be provided with timing advance (TA) information, e.g. in a ‘targetTA’ information element that refers to a timing adjustment indication indicating a value of a timing offset (NTA) between uplink and downlink radio frames, for the UE 3 to use for a target timing advance group (TAG) (e.g., a primary TAG (PTAG) in the case of a handover or a primary secondary TAG (PSTAG) in the case of a secondary cell group (SCG) change). A TAG is a group of cells sharing the same uplink transmission timing (e.g. a group of cells provided by the same RAN node). A time alignment timer (e.g. time AlignmentTimer) can be configured to define the maximum time since the UE 3 has received TA information (e.g. a TA command) from the base station 5, during which the UE 3 is considered to be synchronised for uplink transmissions in the cell. In other words, the UE 3 is considered to be synchronised for UL transmissions in a particular cell whilst the corresponding time alignment timer is running. If the time alignment timer expires (because the UE 3 has not received TA information from the base station 5 whilst the timer is running), the UE 3 can determine that the UE 3 is no longer synchronised for uplink transmissions in the corresponding cell. Synchronisation can be restored, for example, using the random access procedure described above with reference to FIG. 6. It will be appreciated that some cells may not require the UE 3 to be provided with TA information in order for synchronisation to be achieved. For example, for small cells the propagation delay of transmissions between the UE 3 and the base station 5 may be negligible.

Each TAG may comprise at least one serving cell with configured uplink, and the mapping of each serving cell to a TAG can be configured by RRC. For the primary TAG, the UE 3 may use the PCell as a timing reference, except with shared spectrum channel access where an SCell can also be used in some cases. In a secondary TAG, the UE may use any of the activated SCells of the TAG as a timing reference cell.

The timing advance is used to control UL transmission timing for a UE 3 (e.g. for PUSCH and PUCCH), and improves synchronisation of communication between the UE 3 and the base station 5. UEs 3 that are further from a base station 5 may be configured to use larger TA values to compensate for the propagation delay of radio signals between the UE3 and the base station 5. The TA value corresponds to the time difference between the beginning of an uplink radio frame transmitted by the UE 3, and a corresponding downlink radio frame received at the UE 3. The TA value may be configured to be equal to (or approximately equal to), twice the propagation delay between the UE 3 and the base station 5, plus an additional time offset (the additional time offset corresponding to NTA). In other words, the TA value may be: TA=(2×propagation delay)+NTA×Tc, where NTA has units of Tc, which is equal to 1/(480000×4096) seconds. A value of NTA for use by the UE 3 may be broadcast in a cell of the base station 5 (e.g. using SIB1), or could be transmitted to the UE 3 using dedicated signalling. It will be appreciated that the TA may need to be updated as the UE 3 moves around a cell, since mobility of the UE 3 closer to or further from the base station 5 affects the propagation delay of signals transmitted between the UE 3 and the base station 5. The TA value may be updated by transmitting a change in the TA value to the UE 3. For example, the base station 5 may transmit an indication that the TA value is to be decreased by 17 μs. Alternatively, for example, an absolute value for the new TA value could be transmitted to the UE 3 explicitly. The base station 5 may be configured to determine a new value for the TA based on uplink transmissions received from the UE 3. Timing advance updates can be signalled by the base station 5 to the UE 3 using MAC CE commands.

### RLF in SpCell

A UE 3 may communicate using a Special Cell (SpCell), such as a primary serving cell (PCell) of a Master Cell Group (MCG). If the UE 3 is configured for communication using a secondary cell group (SCG), then the UE 3 may also communicate via a primary SCG cell (PSCell). The MCG is a group of serving cells associated with a Master Node. The SCG is a group of serving cells associated with a Secondary Node. The Master Node and the Secondary Node may communicate via an Xn interface (e.g. Xn-U and/or Xn-C interface) provided between the nodes.

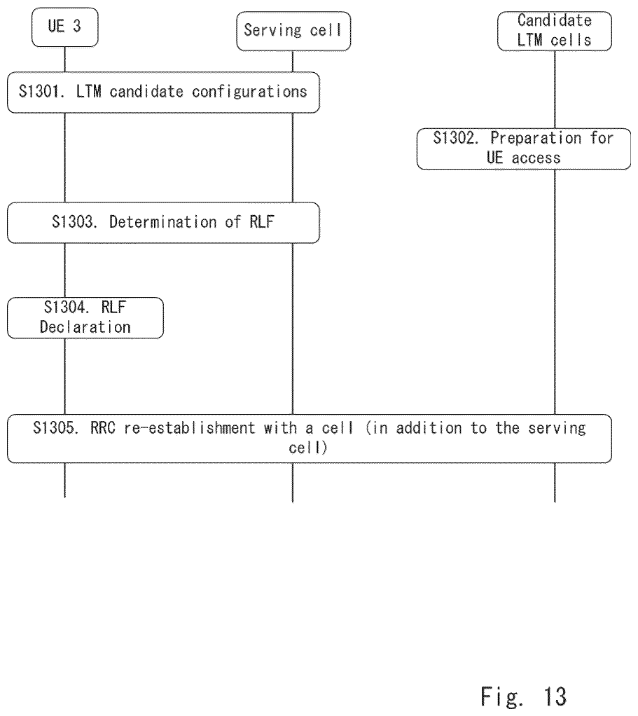

Referring now to FIG. 13 example in which the UE 3 communicates with a base station 5 via an SpCell and determines that RLF has occurred will now be described.

In step S1301, the UE 3 is provided with one or more configurations for LTM candidate cells. Step 1301 may correspond to, for example, step 6 of FIG. 8, including the corresponding cell Radio Network Temporary Identifiers (C-RNTI).

In step S1302 the RAN nodes providing the candidate LTM cells (which could be different base stations 5, or different DUs 50 of the same base station 5) perform preparation for access by the UE 3 (e.g. in response to receiving the UE context setup request message in step 3 of FIG. 8). It will be appreciated that step S1302 could alternatively be performed before step S1301.

In step 1303 the UE 3 performs RLM for transmissions of the serving cell, and it is determined that RLF has occurred between the UE 3 and the serving cell. For example, the UE 3 may determine that RLF has occurred if less than a threshold number of in-sync indications are received before the expiry of an RLF timer, as described above with reference to FIG. 12. RLF may occur, for example, due to the UE 3 leaving a coverage area of the SpCell via which the UE 3 is communicating with a RAN node.

However, the UE 3 may still be within the coverage area of one or more of the candidate LTM cells.

In step S1304 the UE 3 declares RLF. For example, the UE 3 may transmit and indication to the RAN node that provides the serving cell that RLF has occurred. In step S1305 an RRC re-establishment procedure is performed with a cell (in addition to the serving cell, e.g. the PCell of the MCG).

Whilst the method of FIG. 13 has been described with reference to RLF, a similar procedure may be performed for the case of handover failure (which is not depicted in FIG. 13). In the case of LTM based handover failure (HOF), an RRC re-establishment procedure is performed with a cell (in addition to the serving cell, e.g. the PCell of the MCG).

In some examples the RRC re-establishment procedure may be performed with a cell that is not included in the LTM candidate cell set. However, this may increase the delays in recovering from the RLF or HOF, or could cause failure of the recovery from the RLF or HOF. Moreover, even when the RRC re-establishment procedure is performed with a cell of the LTM candidate cell set, an L3-based procedure may increase the time taken to recover from the RLF or HOF, compared to a corresponding L1/L2 based recovery. In order to mitigate against these issues, the UE 3 may be configured to perform a joint RLM process in which the UE 3 monitors both the serving cell and the candidate LTM cells for RLF. Alternatively, the UE 3 may be configured with a single RLM process for monitoring the serving cell, and additional RLM processes for monitoring each of the configured candidate cells for LTM, and may declare RLF either for the serving cell or for one or more of the candidate cells for LTM. In a further alternative, the UE 3 may be configured with a single RLM process for the serving cell, and RLM may not be configured for the candidate LTM cells (but the UE 3 may nevertheless attempt to switch to a candidate LTM cell if the UE 3 determines that RLF has occurred for communication via the serving cell). Beneficially, therefore, the UE 3 can determine not to declare RLF and not to initiate the RRC re-establishment procedure, even if RLF has been detected for the serving cell, when one of the candidate cells for LTM can be used for communication. For example, the UE 3 may be configured to only declare RLF if both the serving cell and none of the candidate LTM cells are available.

However, the present inventors have realised that the reliability and efficiency of recovery from RLF in the serving cell (or for handling HOF) can be improved by considering the availability of the LTM candidate cells. For example, as will be described in more detail below, the reliability and efficiency of recovery from RLF in the serving cell, or from HOF towards a target cell, can be improved by considering which of the candidate LTM cells the UE 3 has up-to-date timing advance parameters available. Particularly advantageous methods and apparatus for improving the reliability and efficiency of recovery from RLF will now be described.

### Fast Recovery Cell Set (FRCS)

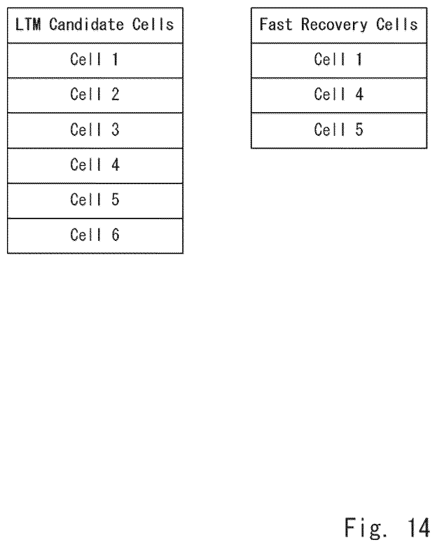

FIG. 14 shows an example in which the UE 3 is provided with a set of fast recovery cells. In this example, the UE 3 is configured with a set of candidate cells for LTM. The UE 3 may receive configuration information for the candidate cells in the RRC Reconfiguration transmission of step 6 of FIG. 8, for example.

In this example the LTM candidate cells include cells 1 to 6. Advantageously, the UE 3 is also provided with a fast recovery cell set for LTM. In this example, cells 1, 4 and 5 are included in the fast recovery cell set. It will be appreciated that the cells may be identified in the LTM candidate cell set and the fast recovery cell set using any suitable information for identifying the cells (e.g. by storing corresponding IDs of the cells). The additional set of cells is referred to as a set of ‘fast recovery’ cells. In this example, the set of fast recovery cells is a subset of the LTM candidate cells (although this need not necessarily be the case). In this example, the UE 3 determines to include a cell in the fast recovery cell set based on whether the UE 3 stores valid timing advance information for that cell. For example, the UE 3 determines that the UE 3 stores valid timing advance information for Cell 1, and therefore determines to include Cell 1 in the set of fast recovery cells. As described above, a time alignment timer (e.g. time AlignmentTimer) can be configured to define the maximum time since the UE 3 has received TA information (e.g. a TA command), during which the UE 3 is considered to be synchronised for uplink transmissions in the corresponding cell. The UE 3 may be configured to include a cell in the fast recovery cell set if the corresponding time alignment timer has not expired. The UE 3 may also be configured to remove a cell from the fast recovery cell set if the corresponding time alignment timer has expired. In other words, the UE 3 may be configured to add a cell to the fast recovery cell set (or maintain a cell in the fast recovery cell set) if the UE 3 is synchronised for UL transmissions in that cell. Similarly, the UE 3 may be configured to remove a cell from the fast recovery cell set if the UE 3 is not synchronised for UL transmissions in that cell.

Following RLF in the serving cell, or following HOF towards a target cell, the UE 3 determines to establish a connection via one of the fast recovery cells. In other words, the UE 3 is configured to prioritise the candidate cells included in the fast recovery cell set, to recover from the RLF in the serving cell, or from the HOF towards the target cell. Advantageously, therefore, since the UE 3 prioritises connection to one of the fast recovery cells for which the UE 3 stores valid timing advance information, the risk that connection to the candidate cell will fail (or will be delayed) is beneficially reduced. As will be described in more detail later, the UE 3 is beneficially able to re-establish the RRC connection via RACH-less access to one of the cells included in the fast recovery cell set (FRCS).

As will be described in more detail later, the UE 3 may provide an indication (e.g. using an UL MAC CE, e.g. a dedicated MAC CE) of which cells are in the fast recovery cell set to the RAN node that provides the serving cell. For example, the UE 3 may determine to add a cell to the fast recovery cell set, and then transmit an indication (e.g. a L1, L2 or L3 indication) to the RAN node that the cell has been added. Alternatively, for example, the UE 3 could transmit an indication to the RAN node that the UE 3 stores valid timing advance information for a particular cell, and RAN node may determine to transmit an indication (e.g. using a MAC CE, e.g. a dedicated MAC CE, or any other suitable L1, L2 or L3 transmissions) to the UE 3 that the UE 3 is to add that cell to the fast recovery cell set. Advantageously, therefore, synchronisation between the fast recovery cell set stored at the UE 3 and the fast recovery cell set stored for the UE 3 at the RAN node that provides the source/serving cell can be maintained.

In addition to the cells of the fast recovery cell set being prioritised for connection over the cells of the LTM candidate cell set, the cells may also be ranked within the fast recovery cell set. For example, the UE 3 may perform measurements of RSRP, RSRQ and/or RSRP-SINR for each of the cells of the fast recovery cell set, and prioritise connection to the cells having the best RSRP, RSRQ and/or RSRP-SINR (the UE 3 may prioritise the cells for which the communication quality is measured to be better). The UE 3 may perform these measurements periodically. Alternatively, the UE 3 may perform the measurements under control of the network (e.g. in response to receiving a corresponding indication and/or measurement configuration information, for example a measurement gap, from the base station 5).

### RLF Recovery and FRCS

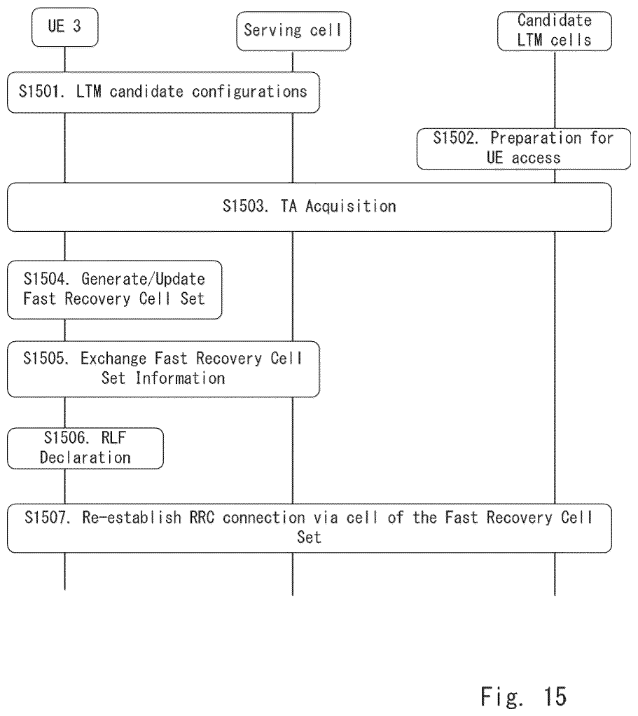

FIG. 15 shows an example in which the UE 3 stores a FRSC, and RLF occurs in the serving cell.

Step S1501 corresponds to step S1301 of FIG. 13, in which the UE 3 is provided with one or more configurations for LTM candidate cells.

Step S1502 corresponds to step S1302 of FIG. 13, in which one or more RAN node s providing the candidate LTM cells (which may be different base stations 5, or different DUs 50 of the same base station 5 that provides the source/serving cell) perform preparation for access by the UE 3 (e.g. in response to receiving the UE context setup request message in step 3 of FIG. 8). It will be appreciated that step S1502 could alternatively be performed before step S1501.

In step S1503 the UE 3 acquires timing advance information for one or more of the LTM candidate cells (the cells indicated to the UE 3 in step S1501). For example, the UE 3 may communicate with one or more base stations 5 that provide the LTM candidate cells, to obtain a corresponding time offset (e.g. NTA, described above). The UE 3 may obtain the TA information for a subset of the LTM candidate cells (e.g. because the UE 3 is unable to obtain the TA information for some of the cells). The UE 3 may obtain the TA information for a subset of the LTM candidate cells, without using or initiating a dedicated TA acquisition procedure, by receiving the TA information in a configuration via the serving cell. Methods of TA acquisition by the UE 3 (e.g. when the UE 3 is not initially provided with the TA information via the serving cell) will be described in more detail later.

In step S1504 the UE 3 generates or updates a fast recovery cell set. The UE 3 is configured to include a cell of the LTM candidate cells in the fast recovery cell set if the valid TA information is available at the UE 3 for that cell. For example, the UE 3 may determine to include a cell in the fast recovery cell set if the UE 3 has received the TA information for the cell and the corresponding time alignment timer has not expired. The UE 3 is also configured to remove a cell from the fast recovery cell set if the corresponding time alignment timer has expired (and so the TA information available at the UE 3 for that cell can be considered to be invalid).

In step S1505, the UE 3 exchanges information regarding the fast recovery cell set with the RAN node that provides the serving cell. The UE 3 may provide, to the RAN node, an explicit or implicit indication of the cells that the UE 3 has determined to include in the fast recovery cell set.

The UE 3 may be configured to repeat steps S1504 and S1505 (e.g. periodically, or based on a timer). For example, the UE 3 may be configured to repeat steps S1504 and S1505 upon TA information for a cell becoming invalid (upon expiry of the corresponding time alignment timer).

Step S1506 corresponds to step S1304 of FIG. 13, in which the UE 3 declares RLF. For example, the UE 3 may transmit and indication to the RAN node that provides the serving cell that RLF has occurred. The UE 3 may determine that RLF has occurred in the SpCell based on an RLF timer and corresponding Out-of-sync and In-Sync indications, as described above with reference to FIG. 12. Following the determination by the UE 3 that RLF has occurred in the serving cell, the UE 3 may be configured to maintain the RRC connection with the serving cell (e.g. for the duration of a corresponding timer) if the UE 3 stores the LTM candidate cell configurations, and there is at least one cell within the fast recovery cell set that is hosted by the same CU 60.

In step S1507 the UE 3 re-establishes an RRC connection via a cell of the fast recovery cell set. The UE 3 may select a cell of the fast recovery cell set based on a corresponding ranking or priority of the cell within the fast recovery cell set (e.g. based on a measured RSRP, RSRQ and/or RSRP-SINR as described above). If re-establishment of the connection via the selected cell is unsuccessful, the UE 3 may attempt to re-establish an RRC connection via the cell of the fast recovery cell set having the next highest priority or ranking. If the UE 3 is unable to establish the connection to any of the cells in the fast recovery cell set (or there are no cells specified in the fast recovery cell set, e.g. because the UE 3 does not store valid TA information for any of the candidate LTM cells), the UE 3 may attempt to establish the connection with another cell that is included in the LTM candidate cell set configured in step S1501 (e.g. using legacy procedure). The UE 3 may be configured to prioritise cells within the fast recovery cell set and/or cells of the LTM candidate cell set as configured by the network (e.g. via the base station 5) during cell (re) selection. If the UE 3 selects a cell that is not included in the fast recovery cell set, then a legacy RRC re-establishment procedure may be used. If the UE 3 selects a cell that is included in the LTM candidate cell set, then the UE 3 may run an autonomous LTM cell switch procedure to access that LTM candidate cell following the RLF.

In step S1507, for the RLF recovery procedure during LTM preparation, the UE's 3 determination to attempt to recover its connection with the network, via a cell for which valid TA information is available at the UE 3 (e.g. a cell from the fast recovery cell set), need not necessarily be a consequence of a cell (re) selection procedure. This is because in order to maintain valid TA information for the cells, the UE 3 has performed corresponding measurements (e.g. periodically) of the cells, and so a traditional cell (re) selection procedure following connection failure (e.g., RLF) need not necessarily be performed.

Advantageously, since the UE 3 stores valid TA information for a target cell of the fast recovery cell set, re-establishment of the RRC connection may be via RACH-less access towards a cell of the fast recovery cell set. RACH-less based access provides reductions in the data connectivity interruption time as it removes the need for performing random access when first accessing the target cell, and hence reduces overall handover execution time.

The recovery of the RRC connection performed by the UE 3 may be an autonomous LTM cell switch, analogous to a conditional handover cell switch. In other words, when the UE 3 is establishing connection to a cell of the fast recovery cell set, the full RRC re-establishment procedure need not necessarily be used following the RLF or HOF, avoiding unnecessary interruption of the procedure.

When there is no change of CU 60 during the LTM Cell Switch procedure, PDCP reestablishment need not necessarily be performed. However, the UE's PDCP data delivery to the lower layer may experience temporary suspension until successful fast recovery is performed to a target cell hosted by the same CU 60. The UE 3 may make a configured grant based UL transmission during this RACH-less LTM Cell Switch for fast recovery, where a C-RNTI MAC CE can be included (with a possible piggybacked BSR). The target cell of the target RAN node can identify the UE 3 via this C-RNTI MAC CE, and update the UE context, which then completes the UE access. Alternatively, the UE 3 can transmit a RRC layer message (e.g., RRCReconfigurationComplete or RRCReestablishment) to the target base station 5 for the purpose of fast recovery announcement.

Whist the method of FIG. 15 has been described with reference to RLF, a corresponding procedure can be used to handle the HOF recovery case. In other words, following HOF (rather than RLF in step S1506), the UE 3 may select a cell of the fast recovery set, and attempt to connect to the selected cell in step S1507.

### TA Acquisition and Maintenance

As described above with reference to step S1503 of FIG. 15, the UE 3 is configured to acquire timing advance information for one or more of the LTM candidate cells (the cells indicated to the UE 3 in step S1501). For example, the UE 3 may communicate with one or more base stations 5 that provide the LTM candidate cells, to obtain a corresponding time offset (e.g. NTA, described above).

The UE 3 may be configured to request one or more PRACH resources for re-acquiring TA information, after expiry of the corresponding TA timer (e.g. the time alignment timer). The UE 3 may be configured to remove the cell from the fast recovery cell set upon expiry of the corresponding TA timer, but can advantageously add the cell back into the fast recovery cell set after the TA information has been re-acquired. Any suitable uplink L1, L2 or L3 transmission could be used to request the more PRACH resources for re-acquiring the TA information. For example, an UL MAC CE (e.g. a dedicated UL MAC CE) could be transmitted from the UE 3 to the RAN node that provides the source/serving cell, to request one or more PRACH resources for re-acquiring the TA information.

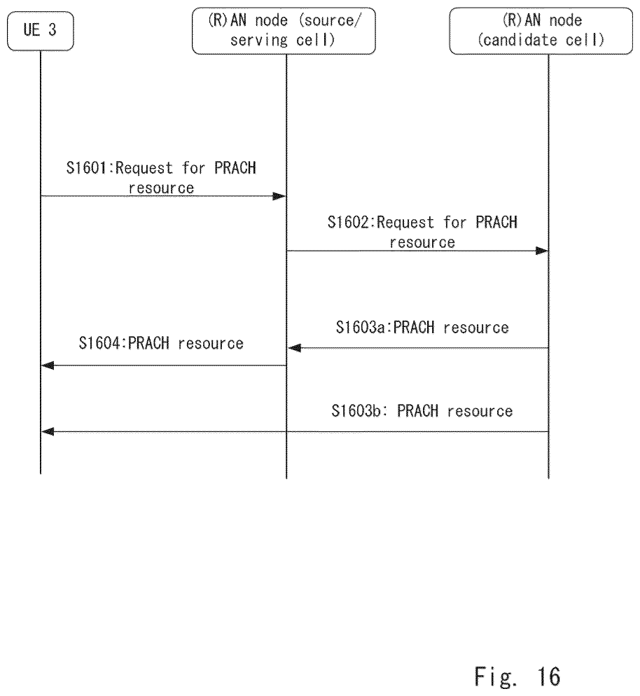

FIG. 16 shows an example in which the access network node that provides the source/serving cell communicates with the access network node that provides a candidate cell for LTM to obtain one or more PRACH resources requested by the UE 3 for obtaining the TA information.

In step S1601, the UE 3 transmits a request for one or more PRACH resources for re-acquiring TA information, after expiry of the corresponding TA timer (e.g. the time alignment timer) for a cell. Alternatively, the request may be for the first acquisition of the TA information for the cell.

In step S1602, the access network node (e.g. DU 50) that provides the source serving cell transmits a corresponding request for one or more PRACH resources to the access network node (e.g. DU 50) that provides the candidate cell.

In step S1603a the access network node that provides the candidate cell transmits one or more requested PRACH resources to the source access network node. In step S1604 the access network node that provides the source/serving cell forwards one or more requested PRACH resources to the UE 3. The source access network node may initiate PDCCH order based RACH with the UE 3. Advantageously, the UE 3 is able to acquire (or re-acquire) the TA information for the candidate LTM cell, and can therefore add the candidate LTM cell to the fast recovery cell list. Alternatively, rather than transmitting the requested PRACH resource via the source access network node, the target access network node could transmit the requested PRACH resource directly to the UE 3, as illustrated in step S1603b.

In a further alternative, rather than the UE 3 requesting one or more PRACH resources for acquiring/re-acquiring the TA information from the access network node that provides the source/serving cell, the source access network node may provide one or more PRACH resources to the UE 3 for acquiring the TA information corresponding to the LTM candidate cells during an initial resource allocation procedure. For example, the PRACH resources could be provided to the UE 3 in step 6 of FIG. 8, or in step S1501 of FIG. 15.

### Additional Cells in Fast Recovery Cell Set

Whilst in the above examples the fast recovery cell set has been described as only including cells for which valid TA information is available at the UE 3, this need not necessarily be the case. Alternatively, the fast recovery cell set may also include cells for which valid TA information is not available at the UE 3 (e.g. the UE 3 is unable to obtain TA information for the cell, or the UE 3 obtained TA information for the cell but the corresponding timer has expired). When the fast recovery cell set may also include cells for which valid TA information is not available at the UE 3, these cells may be assigned/allocated a lower priority by the UE 3. The UE 3 may be configured to attempt access to cells of the fast recovery cell set for which valid TA information is available, and then if those access attempts fail the UE 3 may attempt to access a cell of the fast recovery cell set for which valid TA information is not available.

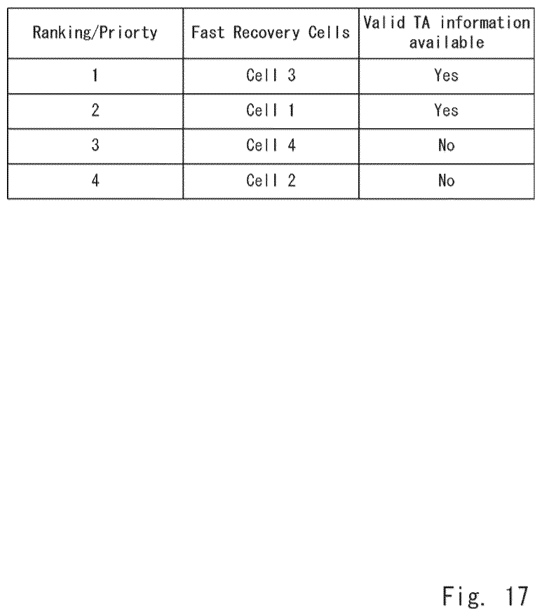

FIG. 17 shows an example in which the fast recovery cell set includes 4 cells, 1 to 4. Cells 3 and 1 have been allocated the highest priority for selection by the UE 3, since valid TA information is available for those cells at the UE 3. Cells 4 and 2 have been allocated lower priority for selection by the UE 3, since valid TA information is not available for those cells. It will be appreciated that cells having a valid TA information may be further ranked/prioritised based on measurements performed by the UE 3. For example, in this example cell 3 is assigned a higher priority for selection by the UE 3 than cell 1, which could be based on measurements of best RSRP, RSRQ and/or RSRP-SINR by the UE 3 for cells 1 and 3. Similarly, in this example cell 4 is assigned a higher priority for selection by the UE 3 than cell 2, which could also be based on measurements of best RSRP, RSRQ and/or RSRP-SINR by the UE 3 for cells 4 and 2.

### Maximum Number Fast Recovery Cells

The maximum number of cells that the UE 3 is to maintain in the fast recovery cell set may be configurable by the network (e.g. via corresponding signalling transmitted from an access network node that provides the source/serving cell to the UE 3). The source base station 5 could transmit an indication of the maximum number of cells to be included in the fast recovery cell set using any suitable transmission, for example using an RRC message (e.g. a dedicated RRC message, or another type of transmission including a dedicated information element). The maximum number of cells that the UE 3 is to maintain in the fast recovery cell set may be, for example, 6 cells, or 9 cells, but could be any other suitable number of cells.

The maximum number of cells that the UE 3 can maintain in the fast recovery cell set may depend on the capabilities of the UE 3 (e.g. the amount of memory that the UE 3 is configured with). The UE 3 may be configured to transmit UE 3 capability information to the base station 5 that indicates the maximum number of cells that the UE 3 is configured to maintain in the fast recovery cell set.

The maximum number of cells for which the UE 3 is to maintain valid TA information (or attempt to maintain valid TA information) may also be configurable by the network (e.g. using an RRC transmission, for example a dedicated RRC transmission), and need not necessarily be the same as the maximum number of cells that can be maintained in the fast recovery cell set. Alternatively, the maximum number of cells for which the UE 3 is to maintain valid TA information may be indicated by the UE 3 to the network, for example by the UE 3 transmitting a corresponding indication to the base station 5, since the maximum number of cells for which the UE 3 can maintain valid TA information may depend on the capabilities (e.g. memory and/or communication capabilities) of the UE 3.

### Early TA Acquisition

As described above, the UE 3 may determine whether to include a cell in the fast recovery cell set based on whether valid TA information is available for that cell at the UE 3. In order to support RACH-less LTM, the TA information for a candidate cell can be acquired via PDCCH ordered (e.g. requested or instructed) RACH, where the PDCCH order is transmitted via the source cell and indicates the candidate cell and/or the RACH Occasion (RO) of the candidate cell is transmitted to the UE 3 in DCI.

Alternatively, or additionally, the network may configure a set of cells for which the UE 3 is to acquire TA information based on the capability of the UE 3 (e.g. memory or communication capability of the UE 3, or based on any other suitable type of UE capability information). The UE 3 may provide UE capability information to the network (e.g. via the base station 5), and the network may determine the LTM candidate cells for which the UE 3 is to acquire the TA information based on the UE capability information.

In a further alternative, the UE 3 may be configured to perform early TA acquisition for a subset of the cells indicated in the LTM candidate cell list (e.g. LTM candidate cells indicated in step 6 of FIG. 8, or step S1301 of FIG. 13) based on one or more conditions or criteria. For example, the UE 3 may be configured to determine to acquire TA information for a cell if the signal strength (e.g. RSRP, or based on a measurement of another suitable quantity such as RSRQ or RSRP-SINR) is greater than a threshold signal strength. The UE 3 may be configured to determine to acquire the TA information for N cells having the best/strongest RSR, P RSRQ or RSRP-SINR, where N may be the maximum number of cells that can be included in the fast recovery cell set described above (but could alternatively be smaller than the maximum number).

The UE 3 may alternatively, or additionally, determine to acquire the TA information for a cell if a valid RACH resource is available for TA information acquisition.

### RLM and Fast Recovery Cell Set

As described above, the UE 3 may be configured to monitor both the serving/source cell and the candidate LTM target cells when performing RLM, to detect RLF. The out-of-sync indications and the in-Sync indications described above with reference to FIGS. 11 and 12 may be generated at the UE 3 based on monitoring of the serving/source cell and the candidate LTM target cells by the UE 3, and the corresponding counts of the number of indications may be the sum of the indications based on all of the monitored cells.

If the UE 3 is configured to perform a joint RLM process in which the UE 3 monitors both the serving cell and the cells within the fast recovery cell set, the count of the number of out-of-sync indications generated at the UE 3 may be based on all of those monitored cells. Advantageously, therefore, this avoids the UE 3 declaring RLF when a sufficient number of in-sync indications are being generated based on measurements for the cells within the fast recovery cell set to reset the RLF timer (T310).

If the UE 3 is configured with a single RLM process for the serving cell, and a single RLM process for each of the cells within the fast recovery cell set, then advantageously RLF may be declared by the UE 3 only if RLF is detected for all of the monitored cells. Advantageously, this avoids the UE 3 declaring RLF when RLF is only detected for the serving cell, but is not detected for at least one cell of the fast recovery cell set.

### User Equipment

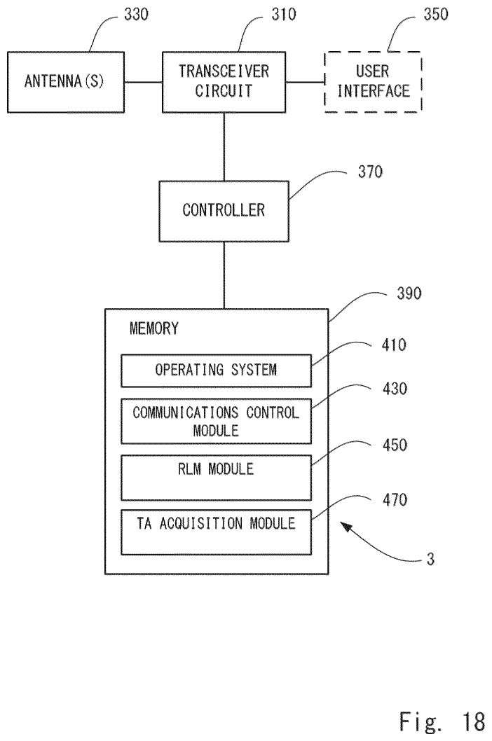

FIG. 18 is a schematic block diagram illustrating the main components of a UE 3 as shown in FIG. 1.

As shown, the UE 3 has a transceiver circuit 310 that is operable to transmit signals to and to receive signals from a base station 5 via one or more antenna 330 (e.g., comprising one or more antenna elements). The UE 3 has a controller 370 to control the operation of the UE 3. The controller 370 is associated with a memory 390 and is coupled to the transceiver circuit 310. Although not necessarily required for its operation, the UE 3 might, of course, have all the usual functionality of a conventional UE 3 (e.g. a user interface 350, such as a touch screen/keypad/microphone/speaker and/or the like for, allowing direct control by and interaction with a user) and this may be provided by any one or any combination of hardware, software, and firmware, as appropriate. Software may be pre-installed in the memory 390 and/or may be downloaded via the telecommunications network or from a removable data storage device (RMD), for example.

The controller 370 is configured to control overall operation of the UE 3 by, in this example, program instructions or software instructions stored within memory 390. As shown, these software instructions include, among other things, an operating system 410, a communications control module 430, an RLM module 450 and a TA acquisition module 470.

The communications control module 430 is operable to control the communication between the UE 3 and one or more its serving base stations 5 (and other communication devices connected to the base station 5, such as further UEs and/or core network nodes). The communications control module 430 is configured for the overall handling uplink communications via associated uplink channels (e.g. via a physical uplink control channel (PUCCH), random access channel (RACH), and/or a physical uplink shared channel (PUSCH)) including both dynamic and semi-static signalling (e.g., SRS). The communications control module 430 is also configured for the overall handling of receipt of downlink communications via associated downlink channels (e.g. via a physical downlink control channel (PDCCH) and/or a physical downlink shared channel (PDSCH)) including both dynamic and semi-static signalling (e.g., CSI-RS). The communications control module 430 is responsible, for example: for determining where to monitor for downlink control information (e.g., the location of CSSs/USSs, CORESETs, and associated PDCCH candidates to monitor); for determining the resources to be used by the UE 3 for transmission/reception of UL/DL communications (including interleaved resources and resources subject to frequency hopping); for managing frequency hopping at the UE side; for determining how slots/symbols are configured (e.g., for UL, DL or SBFD communication, or the like); for determining which one or more bandwidth parts are configured for the UE 3; for determining how uplink transmissions should be encoded; for applying any SBFD specific communication configurations appropriately; and the like. The RLM module 450 may be configured to control communications in accordance with any of the RLM methods described above (for example, to monitor an SpCell or a cell of the fast recovery cell set). The TA acquisition module may be configured to acquire TA information for a cell in accordance with any of the methods described above.

### Base Station

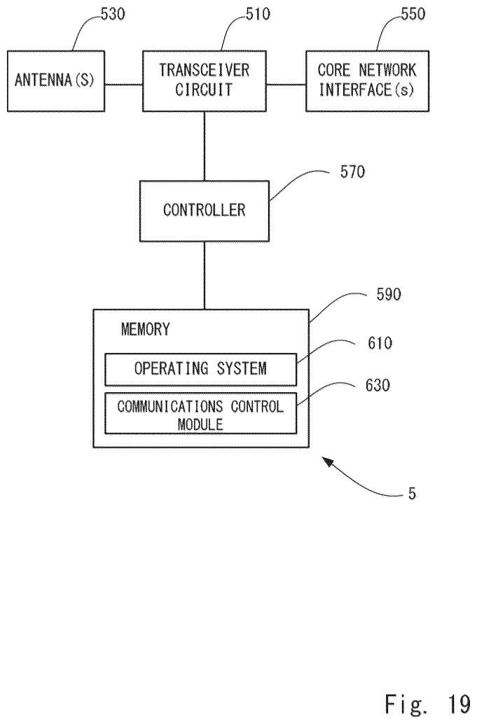

FIG. 19 is a schematic block diagram illustrating the main components of the base station 5 for the communication system 1 shown in FIG. 1. As shown, the base station 5 has a transceiver circuit 510 for transmitting signals to and for receiving signals from the communication devices (such as UEs 3) via one or more antenna 530 (e.g. a single or multi-panel antenna array/massive antenna), and a core network interface 550 (e.g. comprising the N2, N3 and other reference points/interfaces) for transmitting signals to and for receiving signals from network nodes in the core network 7. Although not shown, the base station 5 may also be coupled to other base stations via an appropriate interface (e.g. the so-called ‘Xn’ interface in NR). The base station 5 has a controller 570 to control the operation of the base station 5. The controller 570 is associated with a memory 590. Software may be pre-installed in the memory 590 and/or may be downloaded via the communications network 1 or from a removable data storage device (RMD), for example. The controller 570 is configured to control the overall operation of the base station 5 by, in this example, program instructions or software instructions stored within memory 590.

As shown, these software instructions include, among other things, an operating system 610, and a communications control module 630.

The communications control module 630 is operable to control the communication between the base station 5 and UEs 3 and other network entities that are connected to the base station 5. The communications control module 630 is configured for the overall control of the reception and decoding of uplink communications, via associated uplink channels (e.g. via a physical uplink control channel (PUCCH), a random-access channel (RACH), and/or a physical uplink shared channel (PUSCH)) including both dynamic and semi-static signalling (e.g., SRS). The communications control module 630 is also configured for the overall handling the transmission of downlink communications via associated downlink channels (e.g. via a physical downlink control channel (PDCCH) and/or a physical downlink shared channel (PDSCH)) including both dynamic and semi-static signalling (e.g., CSI-RS). The communications control module 630 is responsible for managing full duplex (e.g., SBFD) communication including, where appropriate, the segregation of UL and DL communication via different physical antenna elements. The communications control module 630 is responsible, for example: for determining where to configure the UE 3 to monitor for downlink control information (e.g., the location of CSSs/USSs, CORESETs, and associated PDCCH candidates to monitor); for determining the resources to be scheduled for UE transmission/reception of UL/DL communications (including interleaved resources and resources subject to frequency hopping); for managing frequency hopping at the base station side; for configuring slots/symbols appropriately (e.g., for UL, DL or SBFD communication, or the like); for configuring one or more bandwidth parts for the UE 3; for providing related configuration signalling to the UE 3; and the like. The communications control module 630 may be configured to control communications in accordance with any of the methods described above (for example, to transmit a requested PRACH resource to the UE 3, or to provide the UE 3 with configuration information for a fast recovery cell set, such as a maximum number of cells for the fast recovery cell set).

### Core Network Node/Function

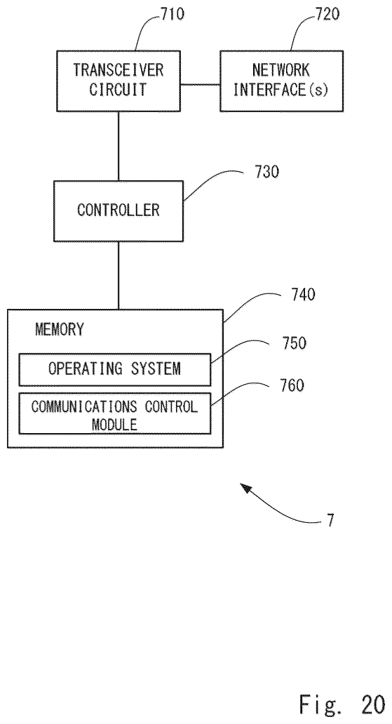

FIG. 20 is a block diagram illustrating the main components of a core network node or function, such as the AMF, CPF, the UPF, the SMF or OAM. As shown, the core network function includes a transceiver circuit 710 which is operable to transmit signals to and to receive signals from other nodes (including the UE 3, the base station 5, and other core network nodes) via a network interface 720. A controller 730 controls the operation of the core network function in accordance with software stored in a memory 740. The software may be pre-installed in the memory 740 and/or may be downloaded via the communication system 1 or from a removable data storage device (RMD), for example. The software includes, among other things, an operating system 750, and a communications control module 760.

The communications control module 760 is responsible for handling (generating/sending/receiving) signalling between the core network function and other nodes, such as the UE 3, the base station 5, and other core network nodes. The communications control module 630 may be configured to perform control of communications in accordance with any of the methods described above.

### Modifications and Alternatives

As those skilled in the art will appreciate, a number of modifications and alternatives can be made to the above example embodiments whilst still benefiting from the disclosure embodied therein.

It will be appreciated, for example, that whilst cellular communication generation (2G, 3G, 4G, 5G, 6G etc.) specific terminology may be used, in the interests of clarity, to refer to specific communication entities, the technical features described for a given entity are not limited to devices of that specific communication generation. The technical features may be implemented in any functionally equivalent communication entity regardless of any differences in the terminology used to refer to them.

In the above description, the UEs and the base station are described for ease of understanding as having a number of discrete functional components or modules. Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities.

In the above example embodiments, a number of software modules were described. As those skilled in the art will appreciate, the software modules may be provided in compiled or un-compiled form and may be supplied as a signal over a computer network, or on a recording medium. Further, the functionality performed by part, or all of this software may be performed using one or more dedicated hardware circuits. However, the use of software modules is preferred as it facilitates the updating of the base station or the UE in order to update their functionalities.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like. Various other modifications will be apparent to those skilled in the art and will not be described in further detail here.

The base station may comprise a ‘distributed’ base station having a central unit ‘CU’ and one or more separate distributed units (DUs).

The User Equipment (or “UE”, “mobile station”, “mobile device” or “wireless device”) in the present disclosure is an entity connected to a network via a wireless interface.

It should be noted that the present disclosure is not limited to a dedicated communication device and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.). A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyser, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table. This list is not exhaustive and is intended to be indicative of some examples of machine type communication applications.

| Service Area | MTC applications |
|---|---|
| Security | Surveillance systems |
| | Backup for landline |
| | Control of physical access (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote | Sensors |
| Maintenance/Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an MVNO (Mobile Virtual Network Operator) service, an emergency radio communication system, a PBX (Private Branch exchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VoLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and example embodiments described in the present document. Needless to say, these technical ideas and example embodiments are not limited to the above-described UE and various modifications can be made thereto.

Various other modifications will be apparent to those skilled in the art and will not be described in further detail here.

For example, the whole or part of the exemplary embodiments disclosed above can be described as, but not limited to, the following supplementary notes.

### (Supplementary Note 1)

A method performed by a user equipment, UE, the method comprising:
receiving, from an access network node that provides a source cell, an indication of a first set of one or more candidate target cells for a lower layer mobility procedure; and
determining a second set of candidate target cells for the lower layer mobility procedure, wherein the second set of cells is a subset of the first set of cells;
wherein the cells in the second set of cells are prioritised for selection as the target cell.

### (Supplementary Note 2)

The method according to supplementary note 1, the method further comprising:
obtaining, for at least one of the candidate cells of the first set, timing advance information for communication using the cell; and
determining to include the candidate cells for which the timing advance information is obtained in the second set of cells.

### (Supplementary Note 3)

The method according to supplementary note 2, the method further comprising:
determining, for a candidate cell for which the timing advance information has been obtained, based on an associated timer, whether the timing advance information is valid;
if it is determined that the timing advance information for the candidate cell is not valid, removing the candidate cell from the second set; and
if it is determined that the timing advance information for the candidate cell is valid, maintaining the candidate cell in the second set.

### (Supplementary Note 4)

The method according to supplementary note 3, wherein the method comprises determining that the timing advance information for the candidate cell is not valid if the timer has expired.

### (Supplementary Note 5)

The method according to any one of supplementary notes 2 to 4, wherein the method further comprises:
receiving, from the access network node or another access network node that provides a cell of the first set of cells, one or more communication resources for use in obtaining the timing advance information; and
obtaining the timing advance information using the one or more communication resources.

### (Supplementary Note 6)

The method according to supplementary note 5, wherein the one or more communication resources comprise one or more physical random access channel, PRACH, resources.

### (Supplementary Note 7)

The method according to supplementary note 5 or 6, wherein the method further comprises transmitting, to the access network node, a request for the one or more communication resources for use in obtaining the timing advance information.

### (Supplementary Note 8)

The method according to any one of supplementary notes 2 to 7, wherein
the second set of cells comprises at least one cell for which valid timing advance information is available at the UE, and the second set of cells comprises at least one cell for which valid timing advance information is not available at the UE; and
the method further comprises determining a ranking or priority for selection of the cells in the second set of cells as a target cell, based on whether valid timing advance information is available for the cells.

### (Supplementary Note 9)

The method according to any one of supplementary notes 2 to 8, wherein the method further comprises receiving, from the access network node, an indication of a maximum number of cells for which the UE is to maintain corresponding timing advance information.

### (Supplementary Note 10)

The method according to any one of supplementary notes 2 to 8, wherein the method further comprises transmitting, to the access network node, an indication of a maximum number of cells for which the UE is to maintain corresponding timing advance information.

### (Supplementary Note 11)

The method according to any one of supplementary notes 2 to 10, wherein the method further comprises:
receiving, from the access network node, an indication of the identity of one or more of the candidate target cells for which the UE is to obtain corresponding timing advance information; and
obtaining the timing advance information for the indicated cells.

### (Supplementary Note 12)

The method according to any one of supplementary notes 2 to 10, wherein the method further comprises:
determining to obtain timing advance information for one or more cells of the first set of cells;
wherein the UE determines whether to obtain timing advance information for a cell based on at least one measurement of a transmission of the cell.

### (Supplementary Note 13)

The method according to supplementary note 12, wherein the UE determines whether to obtain the timing advance information for a cell based on whether a random access channel, RACH, resource for the cell, for obtaining the timing advance information, is available at the UE.

### (Supplementary Note 14)

The method according to any preceding supplementary note, the method further comprising transmitting, to the access network node, an indication of the cells included in the second set of candidate cells.

### (Supplementary Note 15)

The method according to supplementary note 14, wherein the method comprises transmitting, to the access network node, the indication of the cells included in the second set of candidate cells after adding or removing a cell from the second set of cells.

### (Supplementary Note 16)

The method according to any preceding supplementary note, the method further comprising:
performing one or more measurements of transmissions of at least one cell of the second set of cells; and
determining a ranking or priority for selection of the cells in the second set of cells as a target cell based on the measurements.

### (Supplementary Note 17)

The method according to supplementary note 16, wherein the measurements comprise measurements of at least one of a reference signal received power, RSRP, reference signal received quality, RSRQ, or RSRP and signal to noise interference ratio, RSRP-SINR.

### (Supplementary Note 18)

The method according to supplementary note 16 or 17, wherein the method further comprises:
receiving measurement configuration information for the one or more measurements from the access network node; and
performing the one or more measurements based on the measurement configuration information.

### (Supplementary Note 19)

The method according to any preceding supplementary note, wherein the method further comprises:
determining that radio link failure, RLF, has occurred in the source cell; and
performing the lower layer mobility procedure after determining that the RLF has occurred.

### (Supplementary Note 20)

The method according to supplementary note 19, wherein determining that RLF has occurred comprises performing a radio link monitoring, RLM, procedure.

### (Supplementary Note 21)

The method according to supplementary note 20, wherein the RLM procedure comprises performing measurements of transmissions of the source cell.

### (Supplementary Note 22)

The method according to supplementary note 21, wherein the RLM procedure further comprises performing measurements of transmissions of at least one cell of the second set of cells.

### (Supplementary Note 23)

The method according to supplementary note 22, wherein the RLM procedure comprises a first RLM process for monitoring the source cell, and one or more second RLM processes for monitoring cells of the second set of cells.

### (Supplementary Note 24)

The method according to supplementary note 23, wherein the UE determines that RLF has occurred if the UE determines that RLF has occurred for both the source cell and the cells of the second set of cells monitored using the second RLM processes.

### (Supplementary Note 25)

The method according to supplementary note 22, wherein the RLM procedure comprises a joint RLM process for monitoring the source cell and for monitoring cells of the second set of cells.

### (Supplementary Note 26)

The method according to any one of supplementary notes 1 to 18, wherein the method further comprises:
determining that a failure of a handover procedure for handover of the UE from the source cell has occurred; and
performing the lower layer mobility procedure after determining that the failure of the handover procedure has occurred.

### (Supplementary Note 27)

The method according to any preceding supplementary note, wherein the lower layer procedure is a layer 1, L1, or layer 2, L2, based mobility procedure.

### (Supplementary Note 28)

The method according to any preceding supplementary note, wherein the method comprises:
determining that RLF has occurred in the source cell; and
determining to maintain, for a first time period, a configuration for an RRC connection via the source cell if the second set of cells includes at least one cell.

### (Supplementary Note 29)

The method according to supplementary note 28, wherein
the source cell is associated with a central unit of a base station; and
the method comprises determining to maintain, for the first time period, the configuration for the RRC connection via the source cell if the second set of cells includes at least one cell that is associated with the central unit.

### (Supplementary Note 30)

The method according to any preceding supplementary note, wherein the method further comprises determining to perform the lower layer mobility procedure.

### (Supplementary Note 31)

The method according to any preceding supplementary note, wherein the lower layer mobility procedure comprises establishing or re-establishing a radio resource control, RRC, connection via a cell of the second set of cells.

### (Supplementary Note 32)

The method according to any preceding supplementary note, wherein the method further comprises: receiving, from the access network node, an indication of a maximum number of cells to be included in the second set of cells.

### (Supplementary Note 33)

The method according to any one of supplementary notes 1 to 31, wherein the method further comprises: transmitting, to the access network node, an indication of a maximum number of cells that the UE is to include in the second set of cells.

### (Supplementary Note 34)

A method performed by an access network node that provides a source cell, the method comprising:
transmitting, to a user equipment, UE, in the source cell, an indication of a first set of one or more candidate target cells for a lower layer mobility procedure; and
receiving, from the UE, an indication of a second set of candidate target cells for the lower layer mobility procedure, wherein the second set of cells is a subset of the first set of cells;
wherein the cells in the second set of cells are prioritised for selection as a target cell for the lower layer mobility procedure.

### (Supplementary Note 35)

The method according to supplementary note 34, wherein the method further comprises:
transmitting, to the UE, one or more communication resources for use by the UE to obtain timing advance information for a cell of the first set of cells;
wherein the UE determines the cells to be included in the second set of cells based on the timing advance information.

### (Supplementary Note 36)

The method according to supplementary note 35, wherein the one or more communication resources comprise one or more physical random access channel, PRACH, resources.

### (Supplementary Note 37)

The method according to supplementary note 35 or 36, wherein the method further comprises receiving, from the UE, a request for the one or more communication resources for use by the UE to obtain the timing advance information.

### (Supplementary Note 38)

The method according to any one of supplementary notes 34 to 37, wherein the method further comprises transmitting, to the UE, an indication of a maximum number of cells for which the UE is to maintain corresponding timing advance information.

### (Supplementary Note 39)

The method according to any one of supplementary notes 34 to 37, wherein the method further comprises receiving, from the UE, an indication of a maximum number of cells for which the UE is to maintain corresponding timing advance information.

### (Supplementary Note 40)

The method according to any one of supplementary notes 34 to 39, wherein the method further comprises: transmitting, to the UE, an indication of the identity of one or more of the candidate target cells for which the UE is to obtain corresponding timing advance information.

### (Supplementary Note 41)

The method according to any one of supplementary notes 34 to 40, wherein the method further comprises:
transmitting, to the UE, measurement configuration information for one or more measurements to be performed by the UE of transmissions of at least one cell of the second set of cells.

### (Supplementary Note 42)

The method according to any one of supplementary notes 34 to 41, wherein the lower layer procedure is a layer 1, L1, or layer 2, L2, based mobility procedure.

### (Supplementary Note 43)

The method according to any one of supplementary notes 34 to 42, wherein the method further comprises determining to perform the lower layer mobility procedure.

### (Supplementary Note 44)

The method according to any one of supplementary notes 34 to 43, wherein the method further comprises: transmitting, to the UE, an indication of a maximum number of cells to be included in the second set of cells.

### (Supplementary Note 45)

The method according to any one of supplementary notes 34 to 43, wherein the method further comprises: receiving, from the UE, an indication of a maximum number of cells that the UE is to include in the second set of cells.

### (Supplementary Note 46)

A user equipment, UE, comprising:
means for receiving, from an access network node that provides a source cell, an indication of a first set of one or more candidate target cells for a lower layer mobility procedure; and
means for determining a second set of candidate target cells for the lower layer mobility procedure, wherein the second set of cells is a subset of the first set of cells;
wherein the cells in the second set of cells are prioritised for selection as the target cell.

### (Supplementary Note 47)

An access network node configured to provide a source cell, the access network node comprising:
means for transmitting, to a user equipment, UE, in the source cell, an indication of a first set of one or more candidate target cells for a lower layer mobility procedure; and
means for receiving, from the UE, an indication of a second set of candidate target cells for the lower layer mobility procedure, wherein the second set of cells is a subset of the first set of cells;
wherein the cells in the second set of cells are prioritised for selection as a target cell for the lower layer mobility procedure.

This application is based upon and claims the benefit of priority from Great Britain Patent Application No. 2305106.3, filed on Apr. 5, 2023, the disclosure of which is incorporated herein in its entirety by reference.

### REFERENCE SIGNS LIST

1 COMMUNICATION SYSTEM
3 USER EQUIPMENT
5 BASE STATION
7 CORE NETWORK
9 CELL
10 CONTROL PLANE FUNCTIONS
11 USER PLANE FUNCTIONS
20 EXTERNAL DATA NETWORK
50 DISTRIBUTED UNIT (DU)
60 CENTRAL UNIT (CU)
451 TRANSCEIVER CIRCUIT
453 RU INTERFACE
454 CU INTERFACE
457 CONTROLLER
459 MEMORY
461 OPERATING SYSTEM
463 COMMUNICATIONS CONTROL MODULE
465 F1 MODULE
468 DU-RU MODULE
472 DU MANAGEMENT MODULE
473 UE PROFILE MANAGEMENT MODULE
475 MOBILITY MODULE
551 TRANSCEIVER CIRCUIT
554 DU INTERFACE
555 CU INTERFACE
557 CONTROLLER
559 MEMORY
561 OPERATING SYSTEM
563 COMMUNICATIONS CONTROL MODULE
565 F1 MODULE
566 E1 MODULE
568 N2 MODULE
569 N3 MODULE
571 CU-UP MANAGEMENT MODULE
572 CU-CP MANAGEMENT MODULE
573 UE PROFILE MANAGEMENT MODULE
575 MOBILITY MODULE
310 TRANSCEIVER CIRCUIT
330 ANTENNA
350 USER INTERFACE
370 CONTROLLER
390 MEMORY
410 OPERATING SYSTEM
430 COMMUNICATIONS CONTROL MODULE
450 RLM MODULE
470 TA ACQUISTITION MODULE
510 TRANSCEIVER CIRCUIT
530 ANTENNA
550 CORE NETWORK INTERFACE
570 CONTROLLER
590 MEMORY
610 OPERATING SYSTEM
630 COMMUNICATIONS CONTROL MODULE
710 TRANSCEIVER CIRCUIT
720 NETWORK INTERFACE
730 CONTROLLER
740 MEMORY
750 OPERATING SYSTEM
760 COMMUNICATIONS CONTROL MODULE

What is claimed is:

1-22. (canceled)

23. A method performed by a mobile device, the method comprising:
establishing a Radio Resource Control (RRC) connection with an access network node via a source cell;
determining a radio link failure (RLF) on the source cell;
performing a cell reselection of a target cell without a random access procedure, after determining the RLF;
performing a Lower layer Triggered Mobility (LTM) procedure in a case where the selected cell is included in a set of one or more candidate target cells for a LTM procedure; and
performing a RRC connection re-establishment procedure in a case where the selected cell is not included in the set of one of more candidate target cells for the LTM procedure, and
wherein the mobile device has respective timing advance information for each cell of the set of the one or more candidate target cells.

24. The method according to claim 23, wherein
the one or more candidate target cells includes a further set,
the mobile device does not have respective timing advance information for any cell of the further set of the one or more candidate target cells, and
the set of the one or more candidate target cells is prioritized over the further set of the one or more candidate target cells for the reselection as the target cell.

25. The method according to claim 23, further comprising:
synchronizing with the source cell to maintain the set of the one or more candidate target cells.

26. The method according to claim 23, further comprising:
in a case where at least one of the respective timing advance information becomes invalid:
deleting respective cell corresponding to the at least one of the respective timing advance information which becomes invalid, from the set of the one or more candidate target cells, or
requesting a physical random access channel (PRACH) resource for re-acquiring a valid timing advance information for the respective cell corresponding to the at least one of the respective timing advance information.

27. The method according to claim 26, wherein
the PRACH resource is allocated by either the source cell or the target cell based on the requesting the PRACH resource.

28. The method according to claim 26, wherein
the requesting is performed using a media access control control element (MAC CE).

29. The method according to claim 26, further comprising:
reporting, to the source cell, the deleting the respective cell corresponding to the at least one of the respective timing advance information which becomes invalid, from the set of the one or more candidate target cells.

30. The method according to claim 26, further comprising:
determining, based on a time alignment timer, whether the respective timing advance information is invalid.

31. The method according to claim 23, further comprising:
performing measurements on respective cells in the set of the one or more candidate target cells; and
ranking the cells within the set of the one or more candidate target cells, based on a result of the measurements, and wherein
the cell reselection is performed based on the ranking the cells.

32. The method according to claim 23, wherein
the determining the RLF is performed by at least one of:
monitoring out of synchronization of the source cell;
monitoring out of synchronization of a specified number of the source cell and cells in the set of the one or more target cells; or
monitoring out of synchronization of all of the source cell and cells in the set of the one or more target cells.

33. The method according to claim 23, wherein
the performing the cell reselection of the target cell without the random access procedure is performed in a case where the source cell and target cell are both operated by a same central unit of the access network node.

34. The method according to claim 23, further comprising:
receiving the respective timing advance information from the each cell of the set of the one or more candidate target cells, using physical downlink control channel (PDCCH)-ordered random access channel (RACH) wherein
the PDCCH order originates from the source cell, and
the PDCCH order indicates the each cell of the set of the one or more candidate cells and/or a RACH occasion of the each cell of the set of the one or more candidate cells.

35. The method according to claim 23, further comprising:
receiving the respective timing advance information from the each cell of the set of the one or more candidate target cells, based on user equipment (UE) capability.

36. The method according to claim 23, further comprising:
receiving the respective timing advance information from specific cells of the set of the one or more candidate target cells, and
wherein the specific cells satisfy at least one of:
a respective signal strength of the specific cells is greater than a threshold and a valid resource for receiving the respective timing advance information is available, or
a respective signal strength of the specific cells is among the N best cells.

37. The method according to claim 23, further comprising:
receiving, from the access network node, information indicating a maximum number of:
the set of the one or more target cells, and/or
the respective timing advance information which the mobile device can maintain.

38. The method according to claim 23, further comprising:
transmitting, to the access network node, user equipment (UE) capability information indicating a maximum number of:
the set of the one or more target cells which the mobile device can maintain, and/or
the respective timing advance information which the mobile device can maintain.

39. The method according to claim 23, further comprising:
in a case where any of the set of the one or more target cells is unavailable or the mobile device selects the target cell from the further set of the one or more target cells, performing the cell reselection of another cell than the set of the one or more target cells with the random access procedure.

40. A method performed by an access network node, the method comprising:
establishing a Radio Resource Control (RRC) connection with a mobile device, via a source cell;
performing a cell reselection of a target cell without a random access procedure after the mobile device determines a radio link failure on the source cell;
performing a Lower layer Triggered Mobility (LTM) procedure in a case where the selected cell is included in a set of one or more candidate target cells for a LTM procedure; and
performing a RRC connection re-establishment procedure in a case where the selected cell is not included in the set of one of more candidate target cells for the LTM procedure, and
wherein the mobile device has respective timing advance information for each cell of the set of the one or more candidate target cells.

41. A mobile device comprising:
a memory configured to store instructions; and
a processor configured to execute the instructions to:
establish a Radio Resource Control (RRC) connection with an access network node via a source cell;
determine a radio link failure (RLF) on the source cell;
perform a cell reselection of a target cell without a random access procedure, after determining the RLF;
perform a Lower layer Triggered Mobility (LTM) procedure in a case where the selected cell is included in a set of one or more candidate target cells for a LTM procedure; and
perform a RRC connection re-establishment procedure in a case where the selected cell is not included in the set of one of more candidate target cells for the LTM procedure, and
wherein the mobile device has respective timing advance information for each cell of the set of the one or more candidate target cells.

42. An access network node comprising:
a memory configured to store instructions; and
a processor configured to execute the instructions to:
establish a Radio Resource Control (RRC) connection with a mobile device, via a source cell;
perform a cell reselection of a target cell without a random access procedure after the mobile device determines a radio link failure on the source cell;
perform a Lower layer Triggered Mobility (LTM) procedure in a case where the selected cell is included in a set of one or more candidate target cells for a LTM procedure; and
perform a RRC connection re-establishment procedure in a case where the selected cell is not included in the set of one of more candidate target cells for the LTM procedure, and
wherein the mobile device has respective timing advance information for each cell of the set of the one or more candidate target cells.
